(19) United States
(12) Patent Application Publication
(10) Pub. No.: US 2012/0106306 A1
(43) Pub. Date: May 3, 2012

(54) INTEGRATED CIRCUIT AND OPTICAL DISC APPARATUS

(75) Inventors: Kazuhiko Miyazaki, Kanagawa (JP); Shinichi Yamada, Osaka (JP); Masato Asano, Osaka (JP); Yuu Okada, Osaka (JP)

(73) Assignee: PANASONIC CORPORATION, Osaka (JP)

(21) Appl. No.: 13/347,500

(22) Filed: Jan. 10, 2012

Related U.S. Application Data
(63) Continuation of application No. PCT/JP2011/000294, filed on Jan. 20, 2011.

(30) Foreign Application Priority Data
Jan. 26, 2010 (JP) 2010-013740

(51) Int. Cl. G11B 7/004; B41J 2/47; G11B 7/1392

(52) U.S. Cl. 369/44.23; 369/47.19; 347/255; G9B/7.128; G9B/7.009

(57) ABSTRACT

An integrated circuit is provided in an optical disc apparatus for drawing a visible image on an optical disc including a discoloration layer which is discolored by heat or light by irradiating the optical disc with laser light. The integrated circuit includes a tracking direction displacement section configured to execute, when the visible image is drawn, oscillation control to oscillate a position irradiated with the laser light in a radial direction of the optical disc, and a laser modulation section configured to change, when the visible image is drawn, an intensity of the laser light so that the higher a displacement rate of the position irradiated with the laser light in the radiation direction is, the higher the intensity of the laser light becomes.

This is a continuation of PCT International Application PCT/JP2011/000294 filed on Jan. 20, 2011, which claims priority to Japanese Patent Application No. 2010-013740 filed on Jan. 26, 2010. The disclosures of these applications including the specifications, the drawings, and the claims are hereby incorporated by reference in their entirety.

### BACKGROUND

The present disclosure relates to an optical disc apparatus which irradiates an optical disc including an optical discoloration layer which is discolored by heat or light with laser light to draw a visible image thereon, and an integrated circuit provided in the optical disc apparatus.

Conventionally, optical disc apparatuses which irradiate a label surface or a recording surface of an optical disc with laser light to form a visible image (i.e., an image that users can visually perceive) such as texts and designs have been known (see, for example, Japanese Patent Publication No. 2001-283470, Japanese Patent Publication No. 2002-203321, Japanese Patent Publication No. 2004-5847, Japanese Patent Publication No. 2004-355764, and Japanese Patent Publication No. 2003-203348).

An optical disc apparatus of Japanese Patent Publication No. 2004-5847 is configured so that a laser light irradiation position oscillates in a radial direction of an optical disc when a visible image is drawn.

An optical disc apparatus of Japanese Patent Publication No. 2004-355764 is configured so that a signal obtained by performing processings of an encoder and a strategy circuit used for regular data recording to dot data indicating contrast between brightness and darkness of a visible image is supplied to a laser driver. Thus, a pit corresponding to the eight-to-fourteen modulation (EFM) waveform is formed.

Incidentally, when an optical disc is irradiated with laser light having high power (hereinafter referred to as “recording laser power”) that discolors a discoloration layer of the optical disc, an amount of reflected light differs from that when the optical disc is irradiated with laser light having low power that does not discolor the discoloration layer of the optical disc. Thus, if focus control based on reflected light of laser light having recording laser power is performed using the same focus error signal generation section as used for reproduction, the focus control becomes unstable.

Therefore, an optical disc of Japanese Patent Publication No. 2003-203348 is configured so that when a visible image is drawn with laser light having recording laser power, a short period is provided in which laser power is set small enough not to discolor a discoloration layer, and focus control is performed based on reflected light in the period.

### SUMMARY

However, in Japanese Patent Publication No. 2004-5847, when the laser light irradiation position oscillates, the displacement rate of the laser light irradiation position in the radial direction of the optical disc varies, and an irradiation time differs at each irradiation position. As a result, differences in gray level are caused on an irradiation locus of laser light, and a visible image with a uniform gray level cannot be drawn. Accordingly, visibility and quality of a visible image might be reduced.

When a visible image with a uniform gray level is not drawn, if drawing is performed at the same radial position on an optical disc a plurality of times to reduce nonuniform drawing, a problem of increase in drawing time arises.

In view of the foregoing, it is an object of the present disclosure to allow drawing of a visible image having high visibility and quality in a short drawing time.

Normally, a focus error signal is obtained when laser power is set low. Therefore, as in Japanese Patent Publication No. 2004-355764, when a pit corresponding to the EFM waveform is formed, a focus error signal can be generated based on reflected light corresponding to a space portion of the EFM waveform.

However, when a focus error signal is generated based on reflected light corresponding to a space portion of the EFM waveform, a maximal width of the space portion is restricted to 11T defined by the modulation rule of the EFM. Therefore, when the rotation rate of the optical disc is increased, and image drawing at high resolution is intended to be performed, a focus error signal cannot be generated. Accordingly, a problem arises in which high speed image drawing or high resolution image drawing cannot be realized. This problem is noticeable particularly when reflected light from an optical disc is detected by an optical director with less responsiveness.

In view of the foregoing, it is another object of the present disclosure to realize high speed image drawing and high resolution image drawing.

Japanese Patent Publication No. 2003-203348, the optical disc apparatus does not obtain a focus error signal while laser power is set to recording laser power. Thus, a sample hold circuit for holding a focus error signal obtained while laser power is set low is needed. Therefore, a problem arises in which a mounting area in which an integrated circuit is provided on the optical disc apparatus is increased accordingly.

In view of the foregoing, it is another object of the present disclosure to reduce the mounting area of the integrated circuit provided in the optical disc apparatus.

To solve the foregoing problems, in one embodiment, an integrated circuit which is provided in an optical disc apparatus for drawing a visible image on an optical disc including a discoloration layer which is discolored by heat or light by irradiating the optical disc with laser light includes a tracking direction displacement section configured to execute, when the visible image is drawn, oscillation control to oscillate a position irradiated with the laser light in a radial direction of the optical disc, and a laser modulation section configured to change, when the visible image is drawn, an intensity of the laser light so that the higher a displacement rate of the position irradiated with the laser light in the radiation direction is, the higher the intensity of the laser light becomes.

According to this embodiment, the intensity of the laser light is changed so that the higher the displacement rate of the position irradiated with the laser light in the radiation direction is, the higher the intensity of the laser light becomes. Thus, a position irradiated with the laser light for a short irradiation time is irradiated with the laser light having a greater intensity than the intensity of the laser light with which a position is irradiated for a long irradiation time, so that differences in the gray level on an irradiation locus of the laser light are hardly caused. As a result, the gray level of a visible image can be made further uniform, so that the visibility and quality of the visual image can be improved. Also, since image drawing does not have to be performed at the same radial position on the optical disc a plurality of times to reduce nonuniform drawing, the image drawing time can be reduced.

In another embodiment, an integrated circuit which is provided in an optical disc apparatus for drawing a visible image on an optical disc including a discoloration layer which is discolored by heat or light by focusing the laser light on the optical disc by a focusing section to irradiate the optical disc with laser light includes a tracking direction displacement section configured to execute, when the visible image is drawn, oscillation control to oscillate a position irradiated with the laser light in a radial direction of the optical disc, and a focusing section position shift section configured to displace the focusing section in a direction perpendicular to the discoloration layer of the optical disc so that the higher a displacement rate of the position irradiated with the laser light in the radial direction is, the smaller a size of a spot of the laser light in the discoloration layer becomes.

According to this embodiment, the higher the displacement rate of the position irradiated with the laser light in the radial direction is, the smaller the size of the spot of the laser light in the discoloration layer becomes. Thus, at the position irradiated with the laser light for a short irradiation time, heat or light is concentrated in a smaller area, as compared to the position irradiated with the laser light for a long irradiation time, and differences in gray level on an irradiation locus of the laser light are hardly caused. As a result, the gray level of a visible image can be made further uniform, so that the visibility and quality of the visual image can be improved. Also, since image drawing does not have to be performed at the same radial position on the optical disc a plurality of times to reduce nonuniform drawing, the image drawing time can be reduced.

In still another embodiment, an integrated circuit which is provided in an optical disc apparatus for drawing a visible image on an optical disc including a discoloration layer which is discolored by heat or light by irradiating the optical disc with laser light, the optical disc apparatus including a light output section configured to output outgoing laser light, a focusing lens configured to receive and focus the outgoing laser light output by the light output section to irradiate the discoloration layer of the optical disc with the outgoing laser light as irradiation laser light, and a spherical aberration correction lens configured to correct a spherical aberration of the focusing lens, includes a tracking direction displacement section configured to execute, when the visible image is drawn, oscillation control to oscillate a position irradiated with the laser light in a radial direction of the optical disc by moving a position of the focusing lens, and a spherical aberration generation section configured to generate, when the visible image is drawn, a spherical aberration of the focusing lens by displacing the spherical aberration correction lens, the tracking direction displacement section controls the position of the focusing lens so that when the position irradiated with the laser light is positioned at a center of an oscillation width, the entire outgoing laser light enters a photo receiving surface of the focusing lens, and when the position irradiated with the laser light turns, a part of the outgoing laser light is off the photo receiving surface of the focusing lens.

According to this embodiment, when the focusing lens is positioned at the center of the oscillation width and the displacement rate is high, the entire outgoing laser light enters the photo receiving surface of the focusing lens, and thus, the entire outgoing laser light converges at the position irradiated with the laser light. On the other hand, when the focusing lens turns and the displacement rate is reduced to a lowest rate, a part of the outgoing laser light is off the photo receiving surface of the focusing lens, and thus, the outgoing laser light, except the part thereof, converges at the position irradiated with the laser light. Therefore, the position irradiated with the laser light for a short irradiation time is irradiated with stronger laser light than laser light with which the position is irradiated for a long irradiation time, so that differences in the gray level on an irradiation locus of the laser light are hardly caused. As a result, the gray level of a visible image can be made further uniform, so that the visibility and quality of the visual image can be improved. Also, since image drawing does not have to be performed at the same radial position on the optical disc a plurality of times to reduce nonuniform drawing, the image drawing time can be reduced.

In still another embodiment, an integrated circuit which is provided in an optical disc apparatus for drawing a visible image on an optical disc including a discoloration layer which is discolored by heat or light by irradiating the optical disc with laser light with recording laser power in a recording irradiation period indicated by a laser light emitting signal, and irradiating the optical disc with laser light with reproduction laser power in a reproduction irradiation period indicated by the laser light emitting signal includes a focus error signal generation section configured to, when the visible image is drawn, generate a focus error signal based on an amount of reflected light of the laser light with which the optical disc has been irradiated in the reproduction irradiation period, extract the generated focus error signal to output the focus error signal as it is in a predetermined extraction period, and output the focus error signal extracted in the predetermined extraction period in a period other than the predetermined extraction period, and a laser light emitting signal generation section configured to generate a laser light emitting signal when the visible image is drawn, based on image data indicating a contrast between brightness and darkness at each dot forming the visible image, so that a detection space portion which is longer than a maximal width of the space portion defined by a modulation rule employed for recording onto a predetermined optical disc by the optical disc apparatus appears as frequently as or more frequently than a required frequency of extraction of the focus error signal, and the laser light emitting signal generation section generates a sample hold signal indicating the predetermined extraction period corresponding to the detection space portion based on the image data.

According to this embodiment, the detection space portion of the focus error signal is longer than the maximal width defined by the modulation rule employed for recording onto the predetermined optical disc by the optical disc apparatus. Thus, even when the rotation rate of the optical disc is high, or even when an image is drawn with high resolution, the focus error signal can be detected. Therefore, high resolution image drawing and high speed image drawing can be realized.

In still another embodiment, an integrated circuit which is provided in an optical disc apparatus for drawing a visible image on an optical disc including a discoloration layer which is discolored by heat or light by irradiating the optical disc with laser light with recording laser power in a recording irradiation period indicated by a laser light emitting signal, and irradiating the optical disc with laser light with reproduction laser power in a reproduction irradiation period indicated by the laser light emitting signal, the optical disc apparatus including an optical detector configured to be capable of detecting reflected light of the laser light from the optical disc with a reproduction sensitivity for generating a focus error signal when the laser light has the reproduction laser power, and with a recording sensitivity for generating the focus error signal when the laser light has the recording laser power, includes a first focus error signal generation circuit configured to generate, based on the reflected light of the laser light detected by the optical detector, the focus error signal when the laser light has the reproduction laser power, a second focus error signal generation circuit configured to generate, based on the reflected light of the laser light detected by the optical detector, the focus error signal when the laser light has the recording laser power, an image drawing data generation section configured to generate, based on image data to indicate a contrast between brightness and darkness at each dot forming the visible image, image drawing light emitting pattern data, and random data according to a modulation rule employed for recording onto a predetermined optical disc by the optical disc apparatus, a write strategy generation section configured to generate, based on the random data generated by the image drawing data generation section, a write strategy signal indicating a recording irradiation period and a reproduction irradiation period for forming a pit corresponding to the random data, an image drawing light emitting pattern generation section configured to generate, based on the image drawing light emitting pattern data generated by the image drawing data generation section, an image drawing light emitting pattern signal indicating a recording irradiation period and a reproduction irradiation period corresponding to the image drawing light emitting pattern data, a laser light emitting signal output section configured to generate a laser light emitting signal which indicates, as the recording irradiation period, a period indicated as the recording irradiation period by both of the write strategy signal generated by the write strategy generation section and the image drawing light emitting pattern signal generated by the image drawing light emitting pattern generation section, and indicates, as the reproduction irradiation period, a period other than the period indicated as the recording irradiation period, and a switching section configured to, in the reproduction irradiation period indicated by the image drawing light emitting pattern signal, cause the optical detector to detect reflected light with the reproduction sensitivity, and execute first control to activate focus control by the first focus error signal generation circuit and to, in the recording irradiation period indicated by the image drawing light emitting pattern signal, cause the optical detector to detect reflected light with the recording sensitivity, and execute second control to activate focus control by the second focus error signal generation circuit.

According to this embodiment, the focus error signal is generated also when the laser power is set to the recording laser power, and thus, a sample hold circuit for holding the focus error signal obtained while the laser power is set to the reproduction laser power is not necessary. Therefore, the area of the integrated circuit provided in the optical disc apparatus can be reduced accordingly.

According to the present disclosure, the gray level of a visible image can be made further uniform, so that the visibility and quality of the visual image can be improved. Also, since image drawing does not have to be performed at the same radial position on the optical disc a plurality of times to reduce nonuniform drawing, the image drawing time can be reduced.

According to the present disclosure, high resolution image drawing and high speed image drawing can be realized.

According to the present disclosure, the mounting area in which the integrated circuit is provided in the optical disc apparatus can be reduced.

### BRIEF DESCRIPTION OF THE DRAWINGS

FIG. 1 is a block diagram illustrating a configuration of an optical disc apparatus according to a first embodiment.

FIG. 2 is a partial cross-sectional view illustrating an optical disc according to the first embodiment.

FIG. 3 is a block diagram illustrating a configuration of a laser modulation circuit according to the first embodiment.

FIG. 4A is a timing chart showing movement of an object lens when a visible image is drawn according to the first embodiment. FIG. 4B is a timing chart showing an oscillation signal generated by an oscillation signal generation circuit according to the first embodiment. FIG. 4C is a timing chart showing a displacement rate calculated by a displacement rate calculation circuit according to the first embodiment. FIG. 4D is a timing chart showing laser power calculated by a level shift circuit according to the first embodiment.

FIG. 5 is a flow chart showing an operation of a microcomputer according to the first embodiment.

FIG. 6 is a block diagram illustrating a configuration of an optical disc apparatus according to a second embodiment.

FIG. 7 is a block diagram illustrating a configuration of an FC control position shift circuit according to a second embodiment.

FIG. 8A is a timing chart showing movement of an object lens when a visible image is drawn according to the second embodiment. FIG. 8B is a timing chart showing an amount of displacement of the object lens in a direction perpendicular to a discoloration layer calculated by the FC control position shift circuit when a visible image is drawn according to the second embodiment. FIG. 8C is a diagram illustrating a focus position of laser light when a visible image is drawn according to the second embodiment.

FIG. 9 is a block diagram illustrating a configuration of an optical disc apparatus according to a third embodiment.

FIG. 10A is a diagram illustrating a positional relationship among an optical disc, an objective lens, a spherical aberration correction lens, an inner beam, and an outer beam when a spherical aberration generation circuit is in an off state according to the third embodiment. FIG. 10B is a diagram illustrating a positional relationship among an optical disc, an objective lens, a spherical aberration correction lens, an inner beam, and an outer beam when a spherical aberration generation circuit is in an on state according to the third embodiment.

FIG. 11A is a timing chart showing movement of an objective lens when a visible image is drawn according to the third embodiment. FIG. 11B is a diagram illustrating a positional relationship among an objective lens, a spherical aberration correction lens, an inner beam, and an outer beam at a time t0 according to the third embodiment. FIG. 11C is a diagram illustrating a positional relationship among an optical disc, an objective lens, a spherical aberration correction lens, an inner beam, and an outer beam at a time t1 according to the third embodiment.

FIG. 12 is a flow chart illustrating movement of a microcomputer according to a third embodiment.

FIG. 13 is a block diagram illustrating a configuration of an optical disc apparatus according to a fourth embodiment.

FIG. 14 is a block diagram illustrating a configuration of a write strategy generation circuit according to the fourth embodiment.

FIG. 15 is a flow chart illustrating movement of a microcomputer according to the fourth embodiment.

FIG. 16 is a timing chart illustrating movement of an optical disc apparatus according to the fourth embodiment.

FIG. 17 is an enlarged view corresponding to a part surrounded by a frame A of FIG. 16.

FIG. 18 is a block diagram illustrating a configuration of an optical disc apparatus according to a fifth embodiment.

FIG. 19 is a block diagram illustrating a configuration of a write strategy generation circuit according to the fifth embodiment.

FIG. 20 is a timing chart illustrating an operation of the optical disc apparatus of the fifth embodiment.

### DETAILED DESCRIPTION

Embodiments will be described with reference to the accompanying drawings below.

### First Embodiment

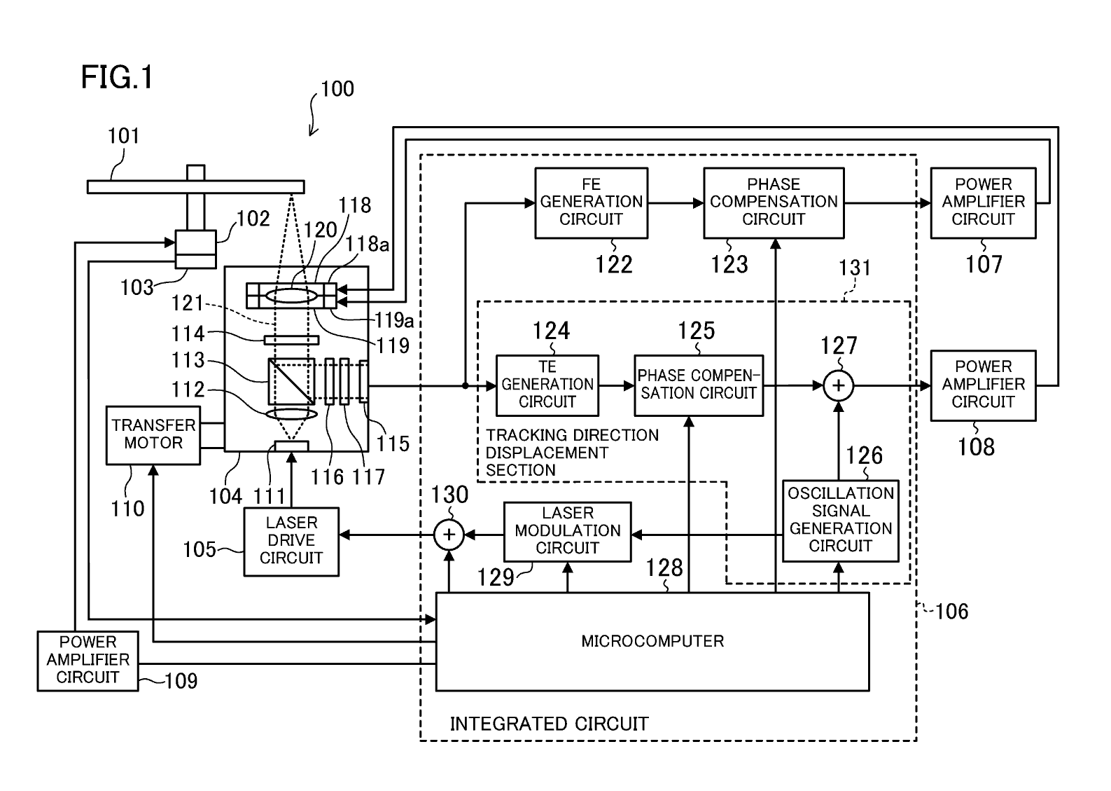

FIG. 1 illustrates an optical disc apparatus 100 according to a first embodiment.

The optical disc apparatus 100 performs recording/reproduction to/from an optical disc 101. The optical disc 101 is configured so that an image can be drawn on a label surface thereof.

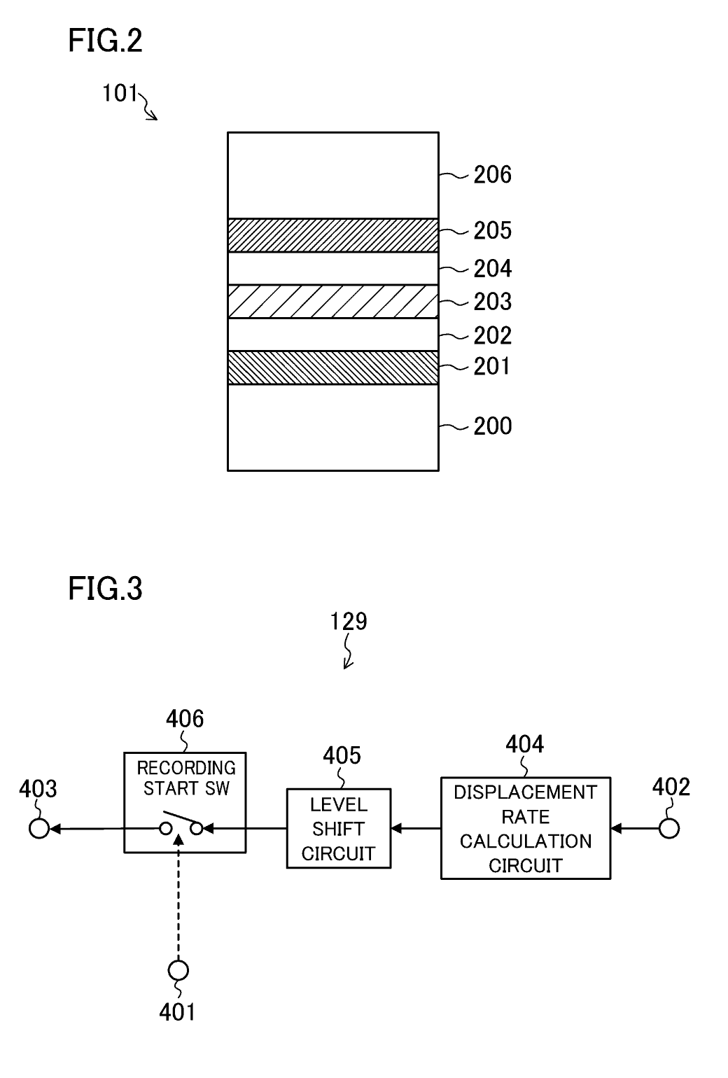

FIG. 2 illustrates a cross section of the optical disc 101. The optical disc 101 is a DVD-R disc. Note that an optical disc of some other type may be used as the optical disc 101.

A portion of the optical disc 101 located at the label surface side has a configuration in which a discoloration layer 201 and a reflection layer 202 are grown in this order on one surface of a first substrate 200 made of, for example, polycarbonate. The discoloration layer 201 is discolored by light. Note that a discoloration layer which is discolored by heat may be used as the discoloration layer 201. A portion of the optical disc 101 located at a recording surface side has a configuration in which a pigment layer 205 and a reflection layer 204 are grown in this order on one surface of a second substrate 206. A bonding adhesion layer 203 for bonding the portion at the label surface side and the portion at the recording surface together is provided between the reflection layer 202 and the reflection layer 204. The thickness of the first substrate 200 and the second substrate 206 is about 0.6 mm. The thicknesses of the discoloration layer 201, the reflection layers 202 and 204, the bonding adhesion layer 203, and the pigment layer 205 are negligibly small, as compared to the thicknesses of the first substrate 200. Thus, an FE signal when the discoloration layer 201 is irradiated with light beam from the label surface side and the FE signal when the pigment layer 205 is irradiated with light beam from the recording surface side have substantially the same characteristics. That is, focus control when an image is drawn on the label surface can be performed in a similar manner to focus control when data is recorded in the recording surface.

As shown in FIG. 1, the optical disc apparatus 100 includes a disc motor 102, an FG generation circuit 103, an optical head 104, a laser drive circuit 105, an integrated circuit 106, power amplifier circuits 107-109, and a transfer motor 110.

The optical disc 101 is placed on the disc motor 102, and the disc motor 102 rotates the optical disc 101 at a predetermined rotation rate. In this embodiment, the optical disc 101 is placed on the disc motor 102 to be irradiated with laser light 121 from the label surface side.

The FG generation circuit 103 generates an FG signal at a frequency corresponding to the rotation rate of the disc motor 102, based on a counter electromotive voltage generated when the disc motor 102 rotates. The FG generation circuit 103 generates an FG signal of 6 pulses per rotation of the disc motor 102. Note that the number of pulses of the FG signal per rotation of the disc motor 102 is not limited to 6.

The optical head 104 includes a laser 111, a coupling lens 112, a polarized light beam splitter 113, a ¼ wavelength plate 114, an optical detector 115, a detection lens 116, a tube lens 117, a focus actuator (focus direction displacement section) 118, a tracking actuator 119, and an object lens (focusing section) 120.

The laser 111 generates laser light 121, and the generated laser light 121 is changed into parallel light by the coupling lens 112 and then passes through the polarized light beam splitter 113 and the ¼ wavelength plate 114. The object lens 120 focuses the laser light 121 which has passed through the ¼ wavelength plate 114 on the discoloration layer 201 at the label surface of the optical disc 101 so that the discoloration layer 201 is irradiated with the laser light 121.

Light reflected from the label surface of the optical disc 101 passes through the object lens 120, the ¼ wavelength plate 114, the polarized light beam splitter 113, the detection lens 116, and the tube lens 117, and enters the optical detector 115. The optical detector 115 detects incident reflected light.

Note that when data is recorded in a recording surface of the optical disc 101 (which is an opposite surface to the label surface), and when data in the recording surface is reproduced, the optical disc 101 is placed on the disc motor 102 to be irradiated with the laser light 121 from the recording surface side. In this case, similar to light reflected from the label surface, light reflected from the recording surface of the optical disc 101 passes through the object lens 120, the ¼ wavelength plate 114, the polarized light beam splitter 113, the detection lens 116, and the tube lens 117, and enters the optical detector 115.

The laser drive circuit 105 drives the laser 111. Laser power at the time of reproduction and laser power at the time of recording are set to the laser drive circuit 105 by a microcomputer 128 and a laser modulation circuit 129, which will be described later.

The focus actuator 118 includes a focusing coil 118a and a permanent magnet (not shown). The object lens 120 is attached to a movable portion of the focus actuator 118. A current corresponding to a voltage output by the power amplifier circuit 107, which will be described later, flows through the focusing coil 118a of the focus actuator 118. The focusing coil 118a receives magnetic force from the permanent magnet, and thus, the object lens 120 moves in a perpendicular direction to the label surface and the recording surface of the optical disc 101 (e.g., the top-and-bottom direction in FIG. 1).

The tracking actuator 119 includes a tracking coil 119a and a permanent magnet (not shown). A current corresponding to a voltage output by the power amplifier circuit 108 flows through the tracking coil 119a of the tracking actuator 119. The tracking coil 119a receives magnetic force from the permanent magnet, and thus, the object lens 120 is displaced in the diameter direction of the optical disc 101 (e.g., the left-and-right direction in FIG. 1).

The integrated circuit 106 includes a focus error signal generation circuit (which will be hereinafter referred to as an FE generation circuit) 122, a phase compensation circuit 123, a tracking error signal generation circuit (which will be hereinafter referred to as a TE generation circuit) 124, a phase compensation circuit 125, an oscillation signal generation circuit 126, an adder circuit 127, a microcomputer (which will be hereinafter referred to as a micon) 128, a laser modulation circuit 129, and an adder 130.

The FE generation circuit 122 generates a focus error signal (which will be hereinafter referred to as an FE signal) indicating a difference between a focus of the laser light 121 and the discoloration layer 201 of the optical disc 101, based on a reflected light amount detected by the optical detector 115.

The phase compensation circuit 123 is a filter which advances the phase of the FE signal generated by the FE generation circuit 122 to output the obtained signal in order to stabilize a focus control system. The phase compensation circuit 123 outputs 0 while focus control is stopped.

The TE generation circuit 124 generates, based on a reflected light amount in an area of an inner circumference of a label surface in which a track is formed in advance, a tracking error signal (which will be hereinafter referred to as a TE signal) indicating a difference between the track and a beam spot of the laser light 121. In general, when a detection method called push-pull method is used, a TE signal is calculated based on a difference signal derived from outputs of a two-divided light detector which receives reflected light of the laser light 121 from the optical disc 101. In the area in which a track is formed, control data for drawing an image is recorded.

The phase compensation circuit 125 is a filter which advances the phase of the TE signal generated by the TE generation circuit 124 to output an obtained signal, in order to stabilize the tracking control system. The phase compensation circuit 125 outputs 0 while tracking control is stopped.

The oscillation signal generation circuit 126 generates an oscillation signal, when an image is drawn on the label surface. The oscillation signal is generated so that a beam spot of the laser light 121 is displaced in the diameter direction on the discoloration layer 201 of the optical disc 101 with predetermined cycle and amplitude. The adder circuit 127 adds an output of the phase compensation circuit 125 and an oscillation signal generated by the oscillation signal generation circuit 126 together.

The TE generation circuit 124, the phase compensation circuit 125, the oscillation signal generation circuit 126, and the adder circuit 127 together form a tracking direction displacement section 131.

When a visible image is drawn, the laser modulation circuit 129 calculates, based on the oscillation signal generated by the oscillation signal generation circuit 126, the displacement rate of a position irradiated with the laser light 121 (a beam spot), and outputs a value of laser power so that the higher the displacement rate is, the higher the intensity of the laser light 121 becomes.

FIG. 3 illustrates a configuration of the laser modulation circuit 129.

The laser modulation circuit 129 includes terminals 401-403, a displacement rate calculation circuit 404, a level shift circuit 405, and a recording start switch (SW) 406.

The terminal 401 is coupled to the micon 128, the terminal 402 is coupled to the oscillation signal generation circuit 126, and the terminal 403 is coupled to the adder 130.

The displacement rate calculation circuit 404 receives an oscillation signal generated by the oscillation signal generation circuit 126 from the terminal 402, and calculates, based on the oscillation signal, the displacement rate of the position irradiated with the laser light 121.

The level shift circuit 405 calculates, based on the displacement rate calculated by the displacement rate calculation circuit 404, laser power at the time of recording, which is to be set to the laser drive circuit 105.

The recording start switch 406 is controlled by the micon 128 to be turned on or off. When the recording start switch 406 is in an on state, the laser power calculated by the level shift circuit 405 is input to the laser drive circuit 105 via the recording start switch 406, and the adder 130 coupled to the terminal 403, and is set. On the other hand, when the recording start switch 406 is in an off state, the laser modulation circuit 129 outputs as the laser power a zero level from the terminal 403, and the zero level is set as the laser power of the laser drive circuit 105.

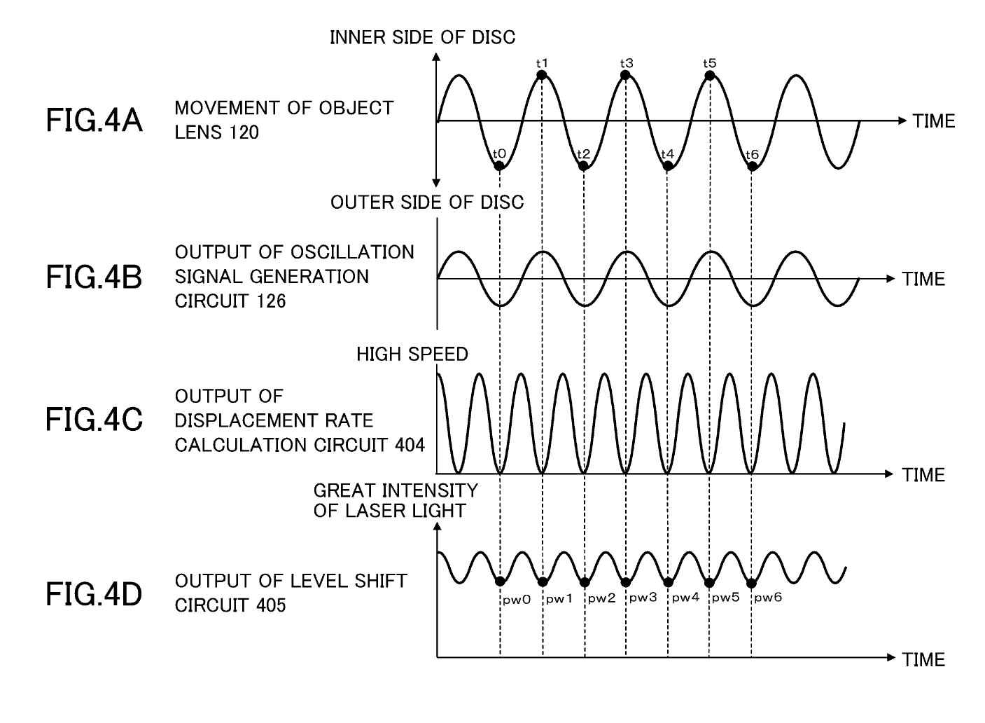

An example operation of the laser modulation circuit 129 will be described below with reference to FIG. 4.

When a visible image is drawn, the oscillation signal generated by the oscillation signal generation circuit 126 has a waveform shown in FIG. 4B, and is sent to the power amplifier circuit 108 via the adder circuit 127. And, a current corresponding to the level of the oscillation signal is supplied to the tracking coil 119a of the tracking actuator 119, and the object lens 120 is displaced in a radial direction of the optical disc 101 as shown in FIG. 4A. The displacement rate calculation circuit 404 calculates, based on the oscillation signal generated by the oscillation signal generation circuit 126, the displacement rate of the object lens 120 shown in FIG. 4C, i.e., the displacement rate of the position irradiated with the laser light 121 on the optical disc 101.

In FIG. 4A, times t0, t1, t2, t3, t4, t5, and t6 are turning timings, at which the displacement rate is the lowest in a period in which the object lens 120 is displaced in a radial direction of the optical disc 101.

The level shift circuit 405 sets, as shown in FIG. 4D, the laser power of the laser light 121 to a minimum level, i.e., pw0, pw1, pw2, pw3, pw4, pw5, and pw6 at the turning timings, at which the displacement rate calculated by the displacement rate calculation circuit 404 is the lowest.

The power amplifier circuit 107 amplifies power output by the phase compensation circuit 123 to supply a current to the focusing coil 118a of the focus actuator 118. According to the FE signal, the object lens 120 is driven by the phase compensation circuit 123 and the power amplifier circuit 107, and a focus of the laser light 121 is controlled to be positioned on the discoloration layer 201 at all the time.

The power amplifier circuit 108 amplifies power output by the adder circuit 127 to supply a current to the tracking coil 119a of the tracking actuator 119. According to the TE signal, the object lens 120 is driven by the phase compensation circuit 125 and the power amplifier circuit 108, and the focus of the laser light 121 is controlled to be positioned on a track at all the time. Note that this tracking control system is also used when data is recorded in the recording surface of the optical disc 101, when data in the recorded surface is reproduced, and when control data in the label surface is reproduced.

The power amplifier circuit 109 amplifies a control signal for the disc motor 102 output by the micon 128 to output the amplified control signal to the disc motor 102.

The transfer motor 110 is, for example, a stepping motor, and moves the optical head 104 in the diameter direction of the optical disc 101. The transfer motor 110 is controlled by the micon 128.

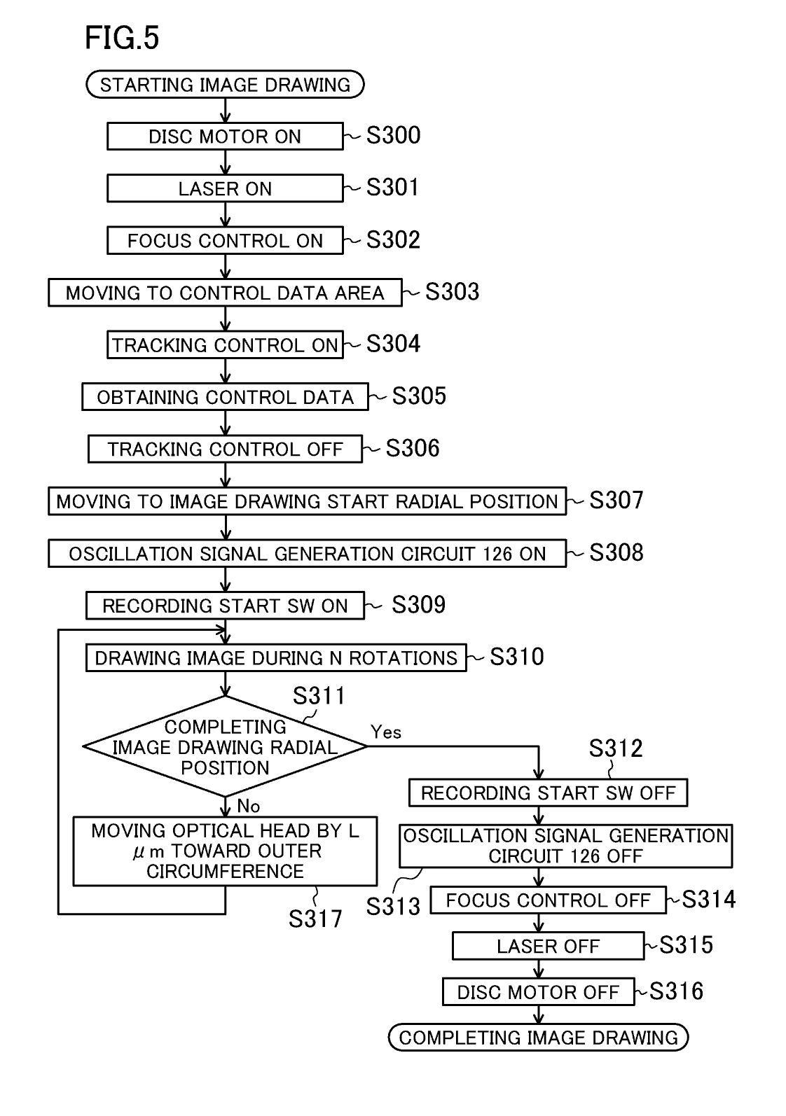

Next, the operation of the micon 128 in the optical disc apparatus 100 configured as described above will be described with reference to FIG. 5.

When a computer etc. instructs the optical disc apparatus 100 to draw an image, the micon 128 outputs a signal for controlling the disc motor 102 to rotate the optical disc 101 at a predetermined rotation rate (S300). Next, the micon 128 controls the laser drive circuit 105 to cause the laser 111 to emit light with reproduction power (S301), thereby activating focus control (S302). Then, the micon 128 controls the transfer motor 110 to move the optical head 104, thereby moving a beam spot of the laser light 121 to a control data area (S303). Next, the micon 128 activates tracking control (S304), obtains control data (S305), and sets laser power at the time of image drawing etc. for drawing an image. Next, the micon 128 stops the tracking control operation (S306) and controls the transfer motor 110, thereby moving the position irradiated with the laser light 121 to an image drawing start radial position (S307). Then, after the oscillation signal generation circuit 126 is operated (S308), the recording start switch 406 is turned on (S309). The optical disc apparatus 100 overwrites the same drawing data for a period in which the optical disc 101 is rotated n times (S310). When the optical disc 101 has been rotated n times, the micon 128 determines whether image drawing up to an image drawing end radial position has been completed in S311. If the image drawing has been competed, the process proceeds to S312, and if the image drawing has not been completed, the process proceeds to S317. In S317, the micon 128 moves the optical head 104 by L μm toward an outer circumference, and the process returns to S309. Then, in S312, the recording start switch 406 is turned off, and the operation of the oscillation signal generation circuit 126 is stopped (S313). Thereafter, focus control is stopped (S314), the laser 111 is turned off (S315), the disc motor 102 is turned off (S316), and image drawing is completed.

According to this embodiment, the intensity of the laser light 121 is changed so that the higher the displacement rate of the position irradiated with the laser light 121 in the radial direction is, the higher the intensity of the laser light 121 becomes. Thus, the position irradiated with the laser light 121 for a short irradiation time is irradiated with the laser light 121 having a greater intensity than the intensity of the laser light 121 with which a position is irradiated for a longer irradiation time, so that differences in the gray level on an irradiation locus of the laser light 121 are hardly caused. As a result, the gray level of a visible image can be made further uniform, so that the visibility and quality of the visual image can be improved. Also, since image drawing does not have to be performed at the same radial position on the optical disc 101a plurality of times in order to reduce nonuniform drawing, the image drawing time can be reduced.

### Second Embodiment

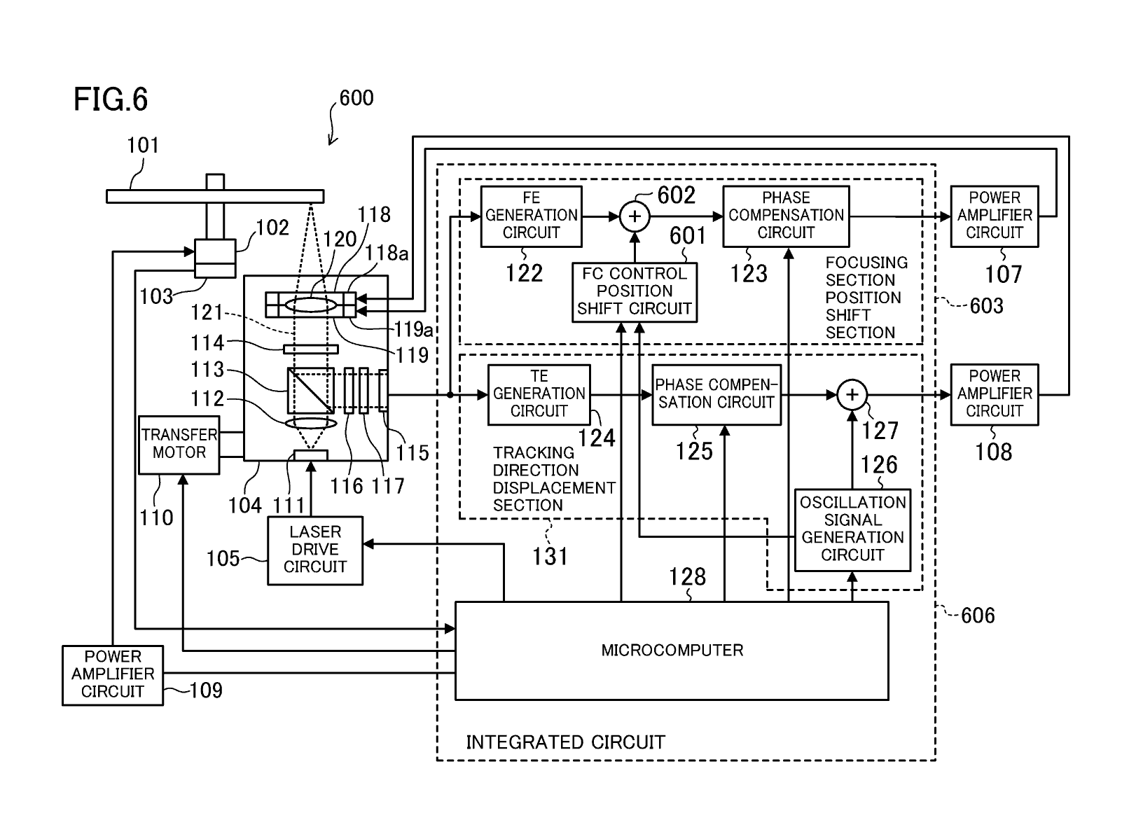

FIG. 6 illustrates an optical disc apparatus 600 according to a second embodiment. Note that each member identified by the same reference character as in the first embodiment performs the same operation of the corresponding member in the first embodiment, and therefore, the description thereof will be omitted.

The optical disc apparatus 600 includes an integrated circuit 606, instead of the integrated circuit 106 of the first embodiment. The integrated circuit 606 includes an FC control position shift circuit 601 and an adder 602, in addition to the members included in the integrated circuit 106 of the first embodiment, and does not include the laser modulation circuit 129 and the adder 130.

The FC control position shift circuit 601 calculates, based on an oscillation signal generated by the oscillation signal generation circuit 126, the displacement rate of a position irradiated with the laser light 121 (a beam spot) in the radial direction, and calculates the displacement amount of the object lens 120 in a direction perpendicular to the discoloration layer 201 of the optical disc 101. The displacement amount is calculated so that the higher the displacement rate is, the smaller the size of the beam spot becomes.

The FE generation circuit 122, the FC control position shift circuit 601, the adder 602, and the phase compensation circuit 123 together form a focusing section position shift section 603.

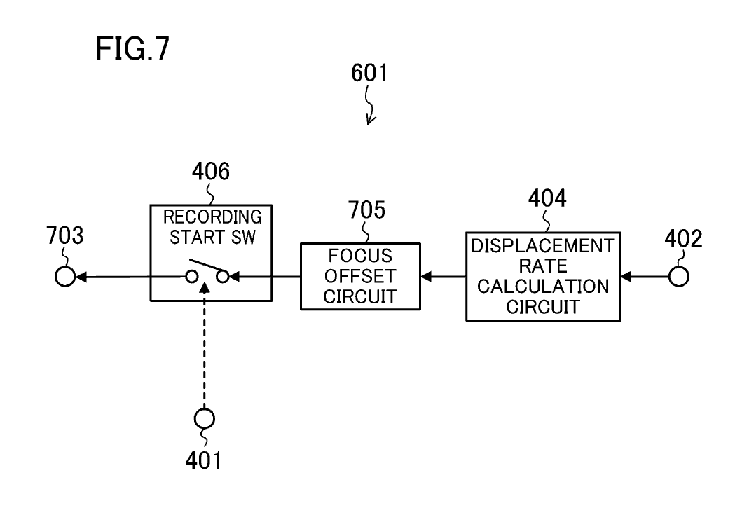

FIG. 7 illustrates a configuration of the FC control position shift circuit 601.

The FC control position shift circuit 601 includes terminals 401, 402, and 703, a displacement rate calculation circuit 404, a focus offset circuit 705, and a recording start switch 406.

The terminal 703 is coupled to the adder 602.

The focus offset circuit 705 calculates, based on the displacement rate calculated by the displacement rate calculation circuit 404, the displacement amount of the object lens 120 in the direction perpendicular to the discoloration layer 201 of the optical disc 101, and outputs a focus offset signal indicating the calculated displacement amount. The displacement amount is calculated so that the higher the displacement rate is, the smaller the size of the beam spot becomes.

When the recording start switch 406 is in an on state, the focus offset signal output by the focus offset circuit 705 is output to the adder 602 coupled to the terminal 703. When the recording start switch 406 is in an off state, the FC control position shift circuit 601 outputs a zero level as laser power from the terminal 703.

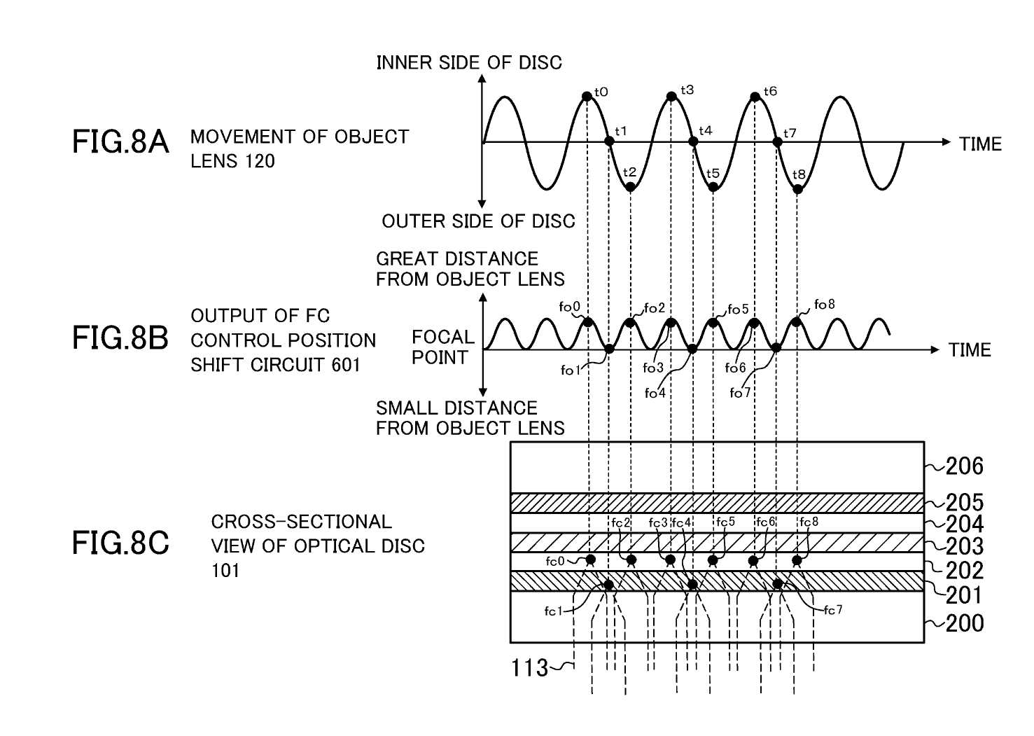

An example operation of the FC control position shift circuit 601 will be described below with reference to FIG. 8.

When a visible image is drawn on a label surface, the oscillation signal generated by the oscillation signal generation circuit 126 is sent to the power amplifier circuit 108 via the adder circuit 127, a current corresponding to the level of the oscillation signal is supplied to the tracking coil 119a of the tracking actuator 119 and, as shown in FIG. 8A, the object lens 120 is displaced in the radial direction of the optical disc 101. Similar to the first embodiment, the displacement rate calculation circuit 404 calculates, based on the oscillation signal generated by the oscillation signal generation circuit 126, the displacement rate of the object lens 120, i.e., the displacement rate of the position irradiated with the laser light 121 in the optical disc 101.

In FIG. 8A, times t0, t2, t3, t5, t6, and t8 denote turning timings at which the displacement rate is the lowest in a period in which the object lens 120 is displaced in the radial direction of the optical disc 101. Times t1, t4, and t7 denote timings at which the displacement rate is the highest.

As shown in FIG. 8B, at turning timings fo0, fo2, fo3, fo5, fo8, and fob at which the displacement rate calculated by the displacement rate calculation circuit 404 is low, the focus offset circuit 705 outputs a focus offset signal to displace a focus of the laser light 121 in a direction from the discoloration layer 201 to the bonding adhesion layer 203, i.e., in a direction away from the object lens 120. Thus, the focus of the laser light 121 is positioned on the reflection layer 202, not on the discoloration layer 201, as shown by fc0, fc2, fc3, fc5, fc6, and fc8 of FIG. 8C. Accordingly, the spot of the laser light 121 on the discoloration layer 201 becomes large, and the intensity per unit area of the laser light 121 with which the discoloration layer 201 is irradiated is reduced. Therefore, even when the displacement rate is low and the irradiation time is long, a visible image formed at the position irradiated with the laser light 121 does not become dark.

On the other hand, at turning timings fo1, fo4, and fo7 at which the displacement rate is high, the focus offset circuit 705 outputs a focus offset signal to cause the focus of the laser light 121 to be positioned on the discoloration layer 201. Thus, the focus of the laser light 121 is positioned on the discoloration layer 201, as shown by fc1, fc4, and fc7 of FIG. 8C. Therefore, the spot of the laser light 121 on the discoloration layer 201 becomes small, and the intensity per unit area of the laser light 121 with which the discoloration layer 201 is irradiated is increased.

In this embodiment, similar to the first embodiment, the micon 128 executes the processings shown by the flow chart of FIG. 5.

According to this embodiment, the higher the displacement rate of the position irradiated with the laser light 121 in the radial direction is, the smaller the size of the spot becomes. Thus, in a part of the discoloration layer 201 located at a position irradiated with the laser light 121 for a short irradiation time, light is concentrated in a smaller area, as compared to a part of the discoloration layer 201 located at a position irradiated with the laser light 121 for a long irradiation time, and differences in gray level on an irradiation locus of the laser light 121 are hardly caused. As a result, the gray level of a visible image can be made further uniform, so that the visibility and quality of the visual image can be improved. Also, since image drawing does not have to be performed at the same radial position on the optical disc 101a plurality of times to reduce nonuniform drawing, the image drawing time can be reduced.

Note that in this embodiment, the size of the spot of the laser light 121 on the discoloration layer 201 is increased by displacing the object lens 120 so that the focus of the laser light 121 moves in a direction away from the object lens 120 at turning timings at which the displacement rate of the laser light 121 is low. However, the size of the spot of the laser light 121 on the discoloration layer 201 may be increased by displacing the object lens 120 so that the focus of the laser light 121 moves in a direction toward the object lens 120.

Also, in this embodiment, the focus offset signal corresponding to the displacement rate of the laser light 121 is added to the FE signal output by the FE generation circuit 122 by the adder 602. However, a signal corresponding to the displacement rate of the laser light 121 may be added to an output of the phase compensation circuit 123, instead.

### Third Embodiment

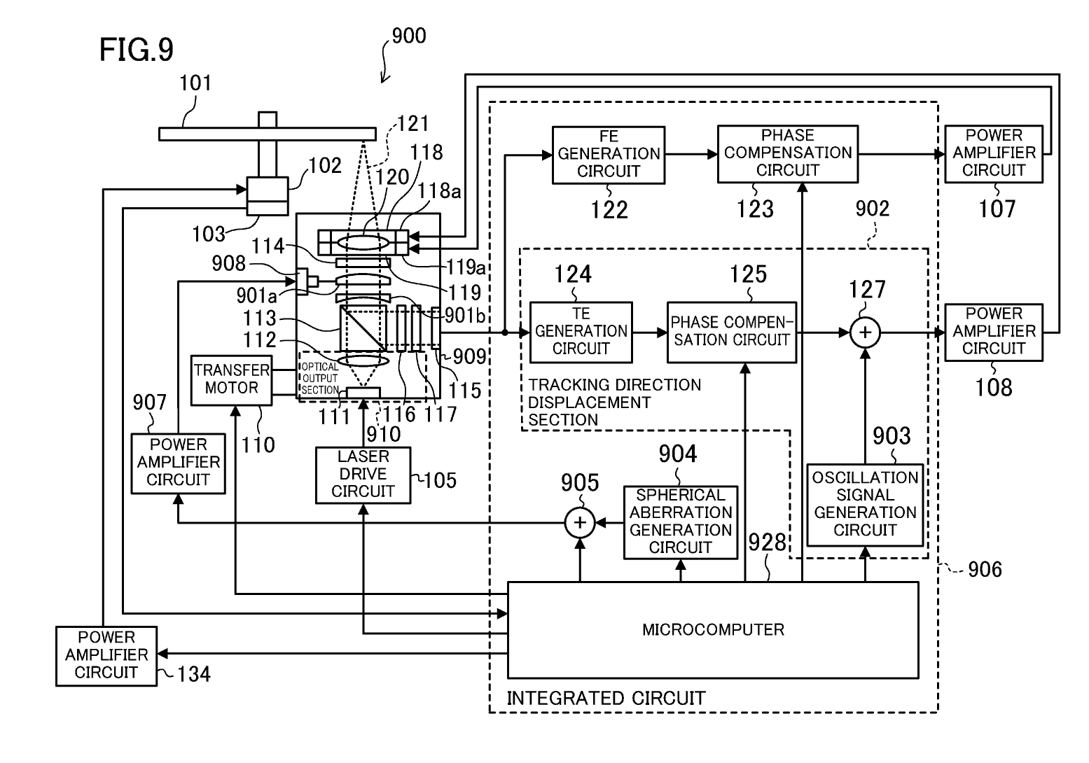

FIG. 9 illustrates an optical disc apparatus 900 according to a third embodiment. Note that each member identified by the same reference character as in the first embodiment performs the same operation of the corresponding member in the first embodiment, and therefore, the description thereof will be omitted.

The optical disc apparatus 900 includes an integrated circuit 906, instead of the integrated circuit 106 of the first embodiment. The integrated circuit 906 includes a tracking direction displacement section 902, instead of the tracking direction displacement section 131 of the first embodiment. The tracking direction displacement section 902 includes an oscillation signal generation circuit 903, instead of the oscillation signal generation circuit 126. The integrated circuit 906 does not include the laser modulation circuit 129 and the adder 130 of the first embodiment, and includes a spherical aberration generation circuit 904 and an adder 905. The integrated circuit 906 includes a micon 928, instead of the micon 128 of the first embodiment.

The oscillation signal generation circuit 903 generates an oscillation signal, when an image is drawn on the label surface. The oscillation signal is generated so that, when the position irradiated with the laser light 121 is at a center of an oscillation range, the entire laser light 121 which has been changed into parallel light by the coupling lens 112 enters the photo receiving surface of the object lens 120, and whereas, when the irradiation position is at a turning point, a part of the laser light 121 which has been changed into parallel light by the coupling lens 112 is off from the photo receiving surface of the object lens 120.

The spherical aberration generation circuit 904 is turned on by the micon 928 at a start of image drawing. When being in an on state, the spherical aberration generation circuit 904 outputs a signal to generate a spherical aberration. On the other hand, when being in an off state, the spherical aberration generation circuit 904 outputs a zero level signal.

When information is recorded on the optical disc 101, and when information recorded in the recording surface is read, the micon 928 controls the spherical aberration generation circuit 904 so that the spherical aberration generation circuit 904 is in an off state. When controlling the spherical aberration generation circuit 904 so that the spherical aberration generation circuit 904 is in an off state, the micon 928 outputs a control signal to control a spherical aberration correction actuator 908 to the adder 905 via a power amplifier circuit 907 so that there is no spherical aberration. When controlling the spherical aberration generation circuit 904 so that the spherical aberration generation circuit 904 is in an on state, the micon 928 outputs, to the adder 905, a control signal with the same value as that when the micon 928 controls the spherical aberration generation circuit 904 so that the spherical aberration generation circuit 904 is in an off state.

The optical disc apparatus 900 includes the power amplifier circuit 907 configured to output a voltage obtained by amplifying an output of the adder 905 to the outside of the integrated circuit 906.

The optical disc apparatus 900 includes an optical head 909, instead of the optical head 104 of the first embodiment. The optical head 909 includes two spherical aberration correction lenses 901a and 901b arranged to face each other, and a spherical aberration correction actuator 908, in addition to the members included in the optical head 104. Note that the laser 111 and the coupling lens 112 together form an optical output section 910.

The spherical aberration correction lenses 901a and 901b correct a spherical aberration of the object lens 120 as a focusing lens.

The spherical aberration correction actuator 908 includes a stepping motor (not shown). The spherical aberration correction lens 901a is attached to a movable body of the spherical aberration correction actuator 908. The stepping motor of the spherical aberration correction actuator 908 operates according to a voltage output by the power amplifier circuit 907 to change a gap between the spherical aberration correction lenses 901a and 901b in the direction perpendicular to the recording surface of the optical disc 101 (the top-and-bottom direction in FIG. 9), thereby adjusting the spherical aberration.

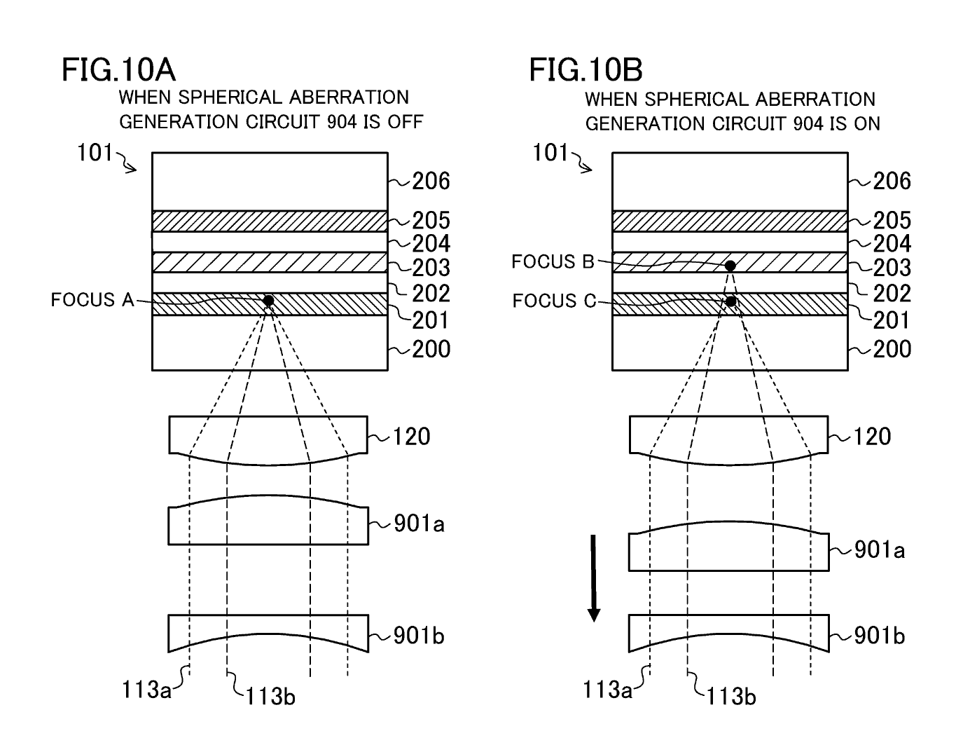

Here, the operation of the spherical aberration generation circuit 904 will be described with reference to FIGS. 10A and 10B. FIGS. 10A and 10B illustrate a focus position of the laser light 121 in a cross section of the optical disc 101. In FIGS. 10A and 10B, the reference character 113a denotes a radial outmost beam of the laser light 121 output in parallel by the coupling lens 112, and the reference character 113b denotes a radial innermost beam of the laser light 121 output in parallel by the coupling lens 112.

When the spherical aberration generation circuit 904 is put into an off state by the micon 928, as shown in FIG. 10A, the spherical aberration correction actuator 908 drives the stepping motor by the control by the micon 928 via the power amplifier circuit 907 to change the gap between the spherical aberration correction lenses 901a and 901b in the direction perpendicular to the information surface of the optical disc 101 (i.e., the top-and-bottom direction in FIGS. 10A and 10B), thereby performing control to cause a state in which there is no spherical aberration. In this state, each of focuses of the outer beam 113a and the inner beam 113b is a focus A in FIG. 10A, and the outer beam 113a and the inner beam 113b overlap with each other in the discoloration layer 201. In this state, heat and light are efficiently transmitted to the discoloration layer 201.

When the spherical aberration generation circuit 904 is put into an on state by the micon 928, a signal obtained by adding an output of the micon 928 and an output of the spherical aberration generation circuit 904 together is sent to the power amplifier circuit 907. The stepping motor of the spherical aberration correction actuator 908 is driven by the output of the power amplifier circuit 907, so that as shown in FIG. 10B, the gap between the spherical aberration correction lenses 901a and 901b in the direction perpendicular to the recording surface of the optical disc 101 (i.e., the top-and-bottom direction in FIGS. 10A and 10B) is reduced. Thus, a spherical aberration is generated. At this time, a focal distance of the inner beam 113b is greater than a focal distance of the outer beam 113a. A focus C of the outer beam 113a is positioned in the discoloration layer 201, and heat and light of the outer beam 113a are concentrated in a small area in the discoloration layer 201. On the other hand, a focus B of the inner beam 113b is not positioned in the discoloration layer 201, and the heat and light of the inner beam 113b scatter in a large area in the discoloration layer 201.

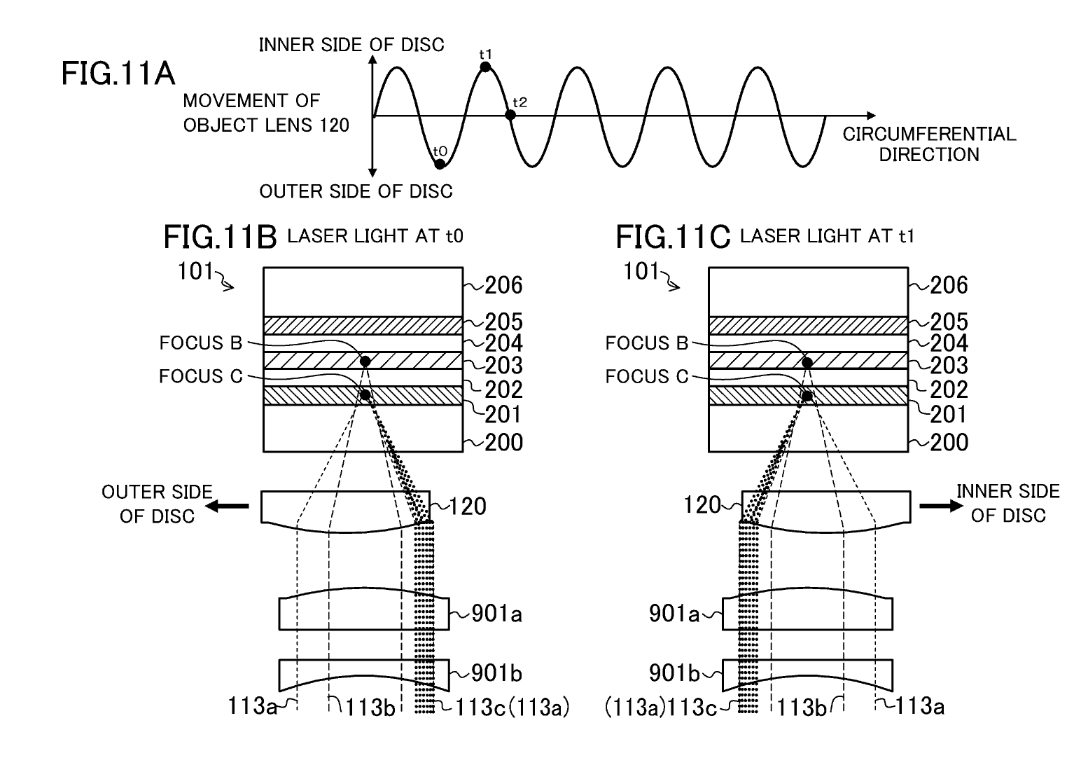

Next, the operation of the optical disc apparatus 900 when a visible image is drawn on the label surface will be described in detail with reference to FIGS. 11A-11C.

When a visible image is drawn on the label surface, the spherical aberration generation circuit 904 is put into an on state. At this time, as shown in FIG. 11A, the object lens 120 undergoes simple harmonic oscillation in the radial direction with predetermined cycle and amplitude, based on an oscillation signal generated by the oscillation signal generation circuit 903. Thus, the beam spot of the laser light 121 undergoes simple harmonic oscillation in the radial direction with predetermined cycle and amplitude on the discoloration layer 201 of the optical disc 101. In FIG. 11A, times t0 and t1 denote timings at which the laser light 121 turns, and the displacement rate is the lowest at the times t0 and t1. In contrast, a time t2 is a timing at which the displacement rate is the highest.

FIG. 11B shows a cross section of the optical disc 101 and the positional relationship among the object lens 120, the spherical aberration correction lenses 901a and 901b, the outer beam 113a, and the inner beam 113b at the time t0. FIG. 11C shows a cross section of the optical disc 101 and the positional relationship among the object lens 120, the spherical aberration correction lenses 901a and 901b, the outer beam 113a, and the inner beam 113b at the time t1.

In FIGS. 11B and 11C, the reference character 113c denotes an ineffective beam which is off from the photo receiving surface of the object lens 120 and does not extend to the optical disc 101.

At the time t0, as shown in FIG. 11B, the object lens 120 is displaced to an outer circumference side of the optical disc 101. At this time, the focus C of the outer beam 113a at the outer circumference side of the optical disc 101 is positioned in the discoloration layer 201, and heat and light of the outer beam 113a at the outer circumference side are efficiently concentrated in a small area in the discoloration layer 201. However, a part of the laser light 121 which is located in the vicinity of the outer beam 113a at an inner circumference side of the optical disc 101 is the ineffective beam 113c, which is off from the object lens 120 and does not extend to the optical disc 101. Therefore, in the discoloration layer 201, the laser light 121 output from the coupling lens 112, except a part thereof, converges, and the light amount of the laser light 121 with which the discoloration layer 201 is irradiated is reduced.

At the time t1, as shown in FIG. 11C, the object lens 120 is displaced to the inner circumference side of the optical disc 101. At this time, the focus C of the outer beam 113a at the inner circumference side of the optical disc 101 is positioned in the discoloration layer 201, and heat and light of the outer beam 113a at the inner circumference side are efficiently concentrated in a small area in the discoloration layer 201. However, a part of the laser light 121 which is located in the vicinity of the outer beam 113a at the outer circumference side of the optical disc 101 is the ineffective beam 113c, which is off from the object lens 120 and does not extend the optical disc 101. Therefore, in the discoloration layer 201, the laser light 121 output from the coupling lens 112, except a part thereof, converges, and the light amount of the laser light 121 with which the discoloration layer 201 is irradiated is reduced.

Note that at the time t2, as shown in FIG. 10B, the position irradiated with the laser light 121 is at the center of the oscillation range, and the entire laser light 121 output by the coupling lens 112 enters the photo receiving surface of the object lens 120. Therefore, no ineffective beam is generated, and the outer beam is in a state where heat and light can be efficiently transmitted to the discoloration layer 201.

Also, note that the spherical aberration generation circuit 904 generates a spherical aberration of the object lens 120 so that a spot of the outer beam 113a in the discoloration layer 201 when a visible image is drawn is smaller than a spot of the outer beam 113a in the pigment layer 205 when data to be reproduced is recorded in the recording surface of the optical disc 101 and when data is reproduced.

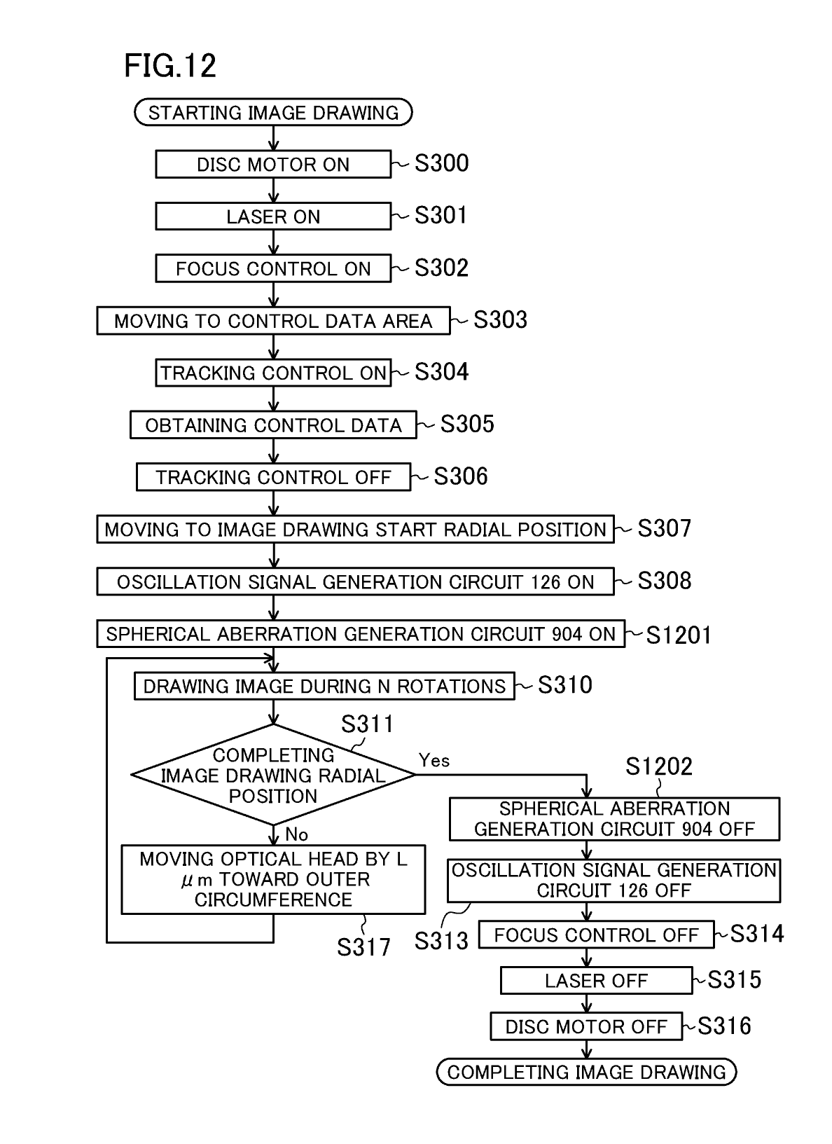

FIG. 12 is a flow chart illustrating the operation of the micon 928 of this embodiment. Each process step identified by the same reference character as in FIG. 5 of the first embodiment is the same process step as in the first embodiment, and therefore, the description thereof will be omitted.

The micon 928 executes steps S1201 and S1202, instead of the steps S309 and S312 of the first embodiment.

The step S1201 is a step of putting the spherical aberration generation circuit 904 into an on state, and the step S1202 is a step of putting the spherical aberration generation circuit 904 into an off state.

According to this embodiment, when the position irradiated with the laser light 121 is at the center of the amplitude range and the displacement rate is high, the entire laser light 121 extends on the photo receiving surface of the object lens 120, so that the entire laser light 121 converges at the position irradiated with the laser light 121. On the other hand, when the position irradiated with the laser light 121 turns and the displacement rate is reduced, one end part of the laser light 121 in the radial direction of the optical disc 101 is off from the photo receiving surface of the object lens 120, and the laser light 121, except a part thereof, converges at the position irradiated with the laser light 121. Thus, the position irradiated with the laser light 121 for a short irradiation time is irradiated with the laser light 121 having a greater intensity than the intensity of the laser light 121 with which a position is irradiated for a long irradiation time, so that differences in the gray level on an irradiation locus of the laser light 121 are hardly caused. As a result, the gray level of a visible image can be made further uniform, so that the visibility and quality of the visual image can be improved. Also, since image drawing does not have to be performed at the same radial position on the optical disc 101a plurality of times to reduce nonuniform drawing, the image drawing time can be reduced.

Note that in this embodiment, when being in an on state, the spherical aberration generation circuit 904 generates a spherical aberration so that the focal distance of the inner beam 113b is greater than the focal distance of the outer beam 113a. However, the spherical aberration may be generated so that the focal distance of the inner beam 113b is smaller than the focal distance of the outer beam 113a.

### Fourth Embodiment

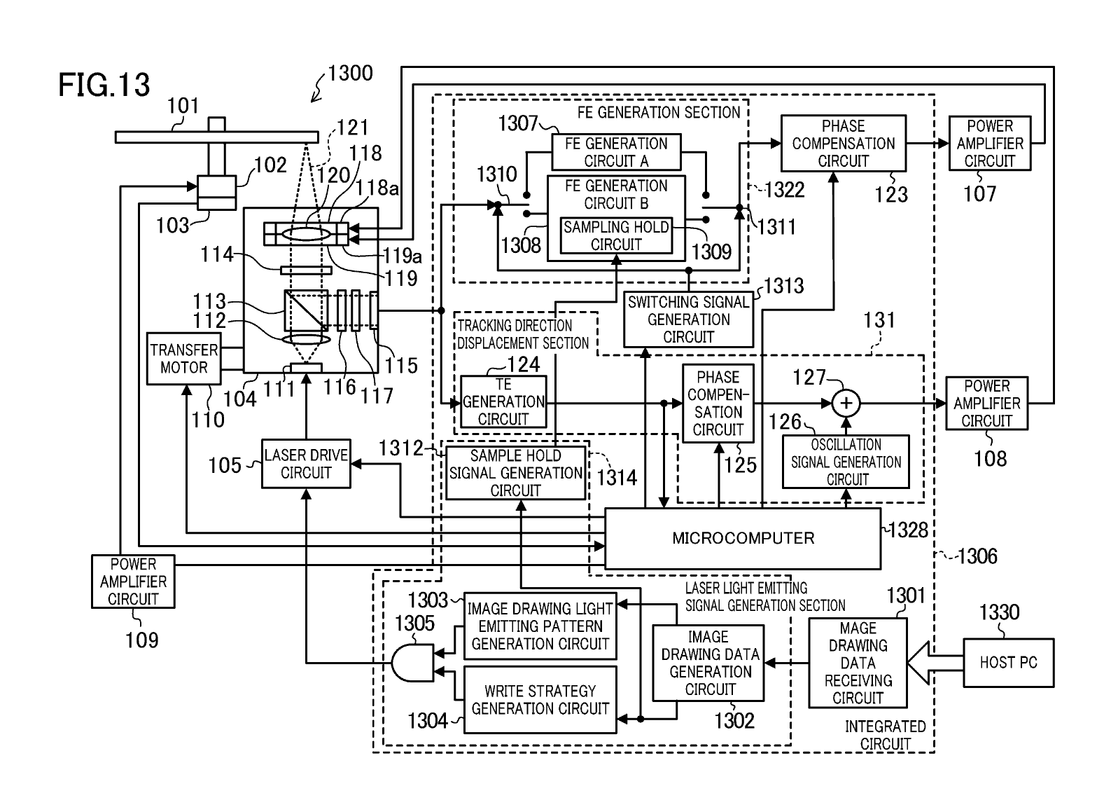

FIG. 13 illustrates an optical disc apparatus 1300 according to a fourth embodiment. Note that each member identified by the same reference character as in the first embodiment performs the same operation of the corresponding member in the first embodiment, and therefore, the description thereof will be omitted.

The optical disc apparatus 1300 includes an integrated circuit 1306, instead of the integrated circuit 106 of the first embodiment. The optical disc apparatus 1300 is configured to also perform recording of data to be reproduced on a compact disc (CD), and an EFM scheme is employed for this recording of the data to be reproduced on the CD.

The integrated circuit 1306 includes an FE generation section 1322, instead of the FE generation circuit 122, and a microcomputer (which will be hereinafter referred to as a micon) 1328, instead of the microcomputer 128. The integrated circuit 1306 does not include the laser modulation circuit 129 and the adder 130, and includes an image drawing data receiving circuit 1301, a laser light emitting signal generation section 1314, and a switching signal generation circuit 1313.

The FE generation section 1322 includes an FE generation circuit A1307 configured to generate an FE signal except for the time when a visible image is drawn on the label surface, and an FE generation circuit B1308 configured to generate an FE signal when a visible image is drawn on the label surface. Each of the FE generation circuit A1307 and the FE generation circuit B1308 includes an amplifier configured to adjust sensitivity for detection of an FE signal and an offset correction circuit configured to adjust an offset of an FE signal provided therein. The FE generation circuit B1308 includes a sample hold circuit 1309 configured to extract and hold an FE signal. Which FE generation circuit is to be used is determined by switching by switches 1310 and 1311 between the FE generation circuit A1307 and the FE generation circuit B1308.

The image drawing data receiving circuit 1301 receives image data indicating a contrast between brightness and darkness at each dot forming a visible image from a host PC 1330.

The laser light emitting signal generation section 1314 generates, based on the image data received by the image drawing data receiving circuit 1301, a laser light emitting signal when a visible image is drawn so that a detection portion which is longer than a maximal width of a space portion defined by the FEM scheme appears as frequently as or more frequently than the required frequency of extraction of an FE signal. The minimum required frequency of extraction of an FE signal is 2000 times per second when a focus control band is 1 kHz, but the frequency of extraction of an FE signal is preferably set to 100000 or more times per second.

More specifically, the laser light emitting signal generation section 1314 includes an image drawing data generation circuit 1302, an image drawing light emitting pattern generation circuit 1303, a write strategy generation circuit 1304, an AND circuit 1305, and a sample hold signal generation circuit 1312.

The image drawing data generation circuit 1302 generates, based on image data, image drawing light emitting pattern data showing a contrast between brightness and darkness of a visible image, and random data according to the EFM scheme. The image drawing light emitting pattern generation circuit 1303 generates, based on the image drawing light emitting pattern data generated by the image drawing data generation circuit 1302, an image drawing light emitting pattern signal indicating a recording irradiation period and a reproduction irradiation period, each corresponding to the image drawing light emitting pattern data. The reproduction irradiation period is a period in which an optical disc is irradiated with the laser light 121 having reproduction laser power, and the recording irradiation period is a period in which an optical disc is irradiated with the laser light 121 having recording laser power. The image drawing light emitting pattern signal is at a low level in the reproduction irradiation period, and at a high level in the recording irradiation period.

The write strategy generation circuit 1304 generates, based on the random data generated by the image drawing data generation circuit 1302 and recording speed sent by the host PC 1330, an extension write strategy signal indicating the recording irradiation period and the reproduction irradiation period so that the detection space portion which is longer than a maximal width of the space portion defined by the FEM scheme appears.

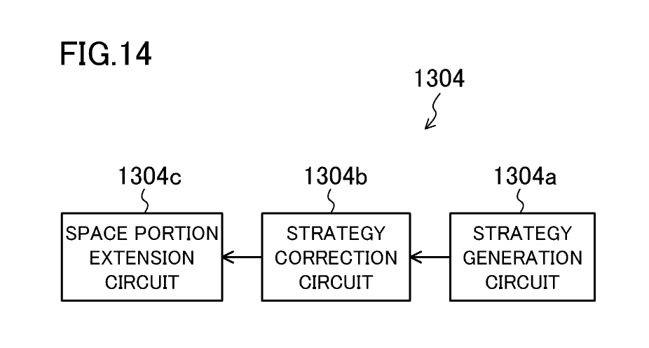

Specifically, as shown in FIG. 14, the write strategy generation circuit 1304 includes a strategy generation circuit 1304a, a strategy correction circuit 1304b, and a space portion extension circuit 1304c.

The strategy generation circuit 1304a generates, based on the random data generated by the image drawing data generation circuit 1302 and the recording speed sent by the host PC 1330, a write strategy signal indicating the recording irradiation period and the reproduction irradiation period for forming a pit corresponding to the random data on the optical disc 101. The frequency of the write strategy signal is sufficiently high, as compared to the frequency of the image drawing light emitting pattern signal generated by the image drawing light emitting pattern generation circuit 1303.

The strategy correction circuit 1304b delays the write strategy signal generated by the strategy generation circuit 1304a to output the delayed signal. The amount of delay is adjustable.

The space portion extension circuit 1304c extends the reproduction irradiation period (a period in which a voltage is at the low level) indicated by the write strategy signal output by the strategy correction circuit 1304b to generate an extension write strategy signal indicating the recording irradiation period and the reproduction irradiation period for forming the detection space portion which is longer than the maximal width of the space portion defined by the FEM scheme. This extension of the reproduction irradiation period is performed only to the reproduction irradiation period having a specific length among reproduction irradiation periods indicated by the write strategy signal. Note that when a predetermined number of reproduction irradiation periods having the specific length successively appear, only the last one of the predetermined number of successive reproduction irradiation periods may be extended. Also, the amount of extension of the reproduction irradiation period may be made variable so that a user can select the amount of extension.

The AND circuit 1305 outputs, as a laser light emitting signal, a logic product of the image drawing light emitting pattern signal generated by the image drawing light emitting pattern generation circuit 1303 and the extension write strategy signal generated by the space portion extension circuit 1304c. That is, the AND circuit 1305 generates, as the laser light emitting signal, a signal which indicates, as a recording irradiation period, a period indicated as a recording irradiation period by both of the image drawing light emitting pattern signal and the extension write strategy signal, and indicates, as a reproduction irradiation period, a period other than the recording irradiation period.

The sample hold signal generation circuit 1312 generates, based on the random data generated by the image drawing data generation circuit 1302, a sample hold signal indicating an extraction period for an FE signal. The sample hold signal is a signal which is at the high level in the extraction period, and is at the low level in a period other than the extraction period. The sample hold signal rises to the high level in the middle of a reproduction irradiation period corresponding to the detection space portion indicated by the extension write strategy signal, and falls to the low level at the end of the reproduction irradiation period.

According to an instruction from the micon 1328, the switching signal generation circuit 1313 switches the switch 1310 and the switch 1311 so that the FE generation circuit B1308 is used for focus control when a visible image is drawn on the label surface of the optical disc 101, and the FE generation circuit A1307 is used for focus control except for the time when a visible image is drawn on the label surface. When the output of the switching signal generation circuit 1313 is at the low level, the FE generation circuit A1307 is used for focus control, and when the output of the switching signal generation circuit 1313 is at the high level, the FE generation circuit B1308 is used for focus control.

The micon 1328 outputs a signal indicating whether a visible image is drawn on the label surface of the optical disc 101 or not, and thereby instructs the switching signal generation circuit 1313 to perform switching between the switch 1310 and the switch 1311.

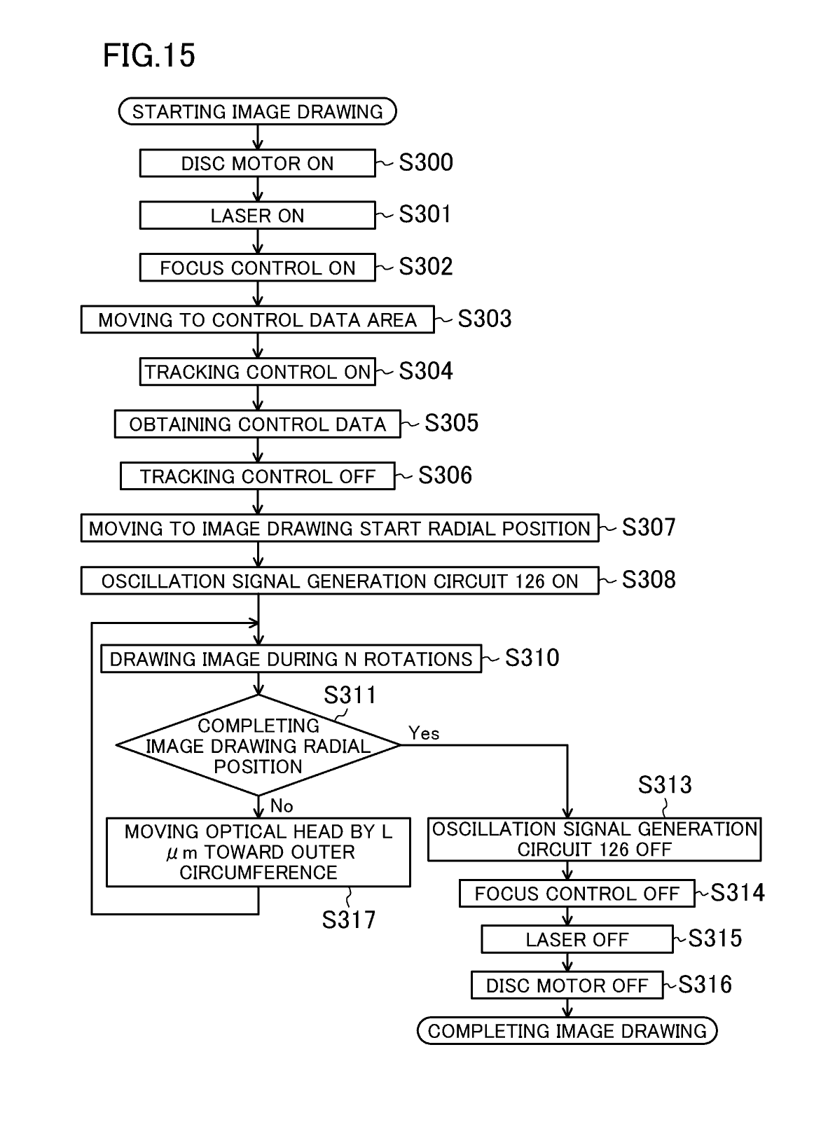

FIG. 15 is a flow chart illustrating the operation of the micon 1328 of this embodiment when a visible image is drawn. Each member identified by the same reference character as in FIG. 5 of the first embodiment performs the same operation of the corresponding member in the first embodiment, and therefore, the description thereof will be omitted.

The micon 1328 does not execute the processings of S309 and S312 of the first embodiment.

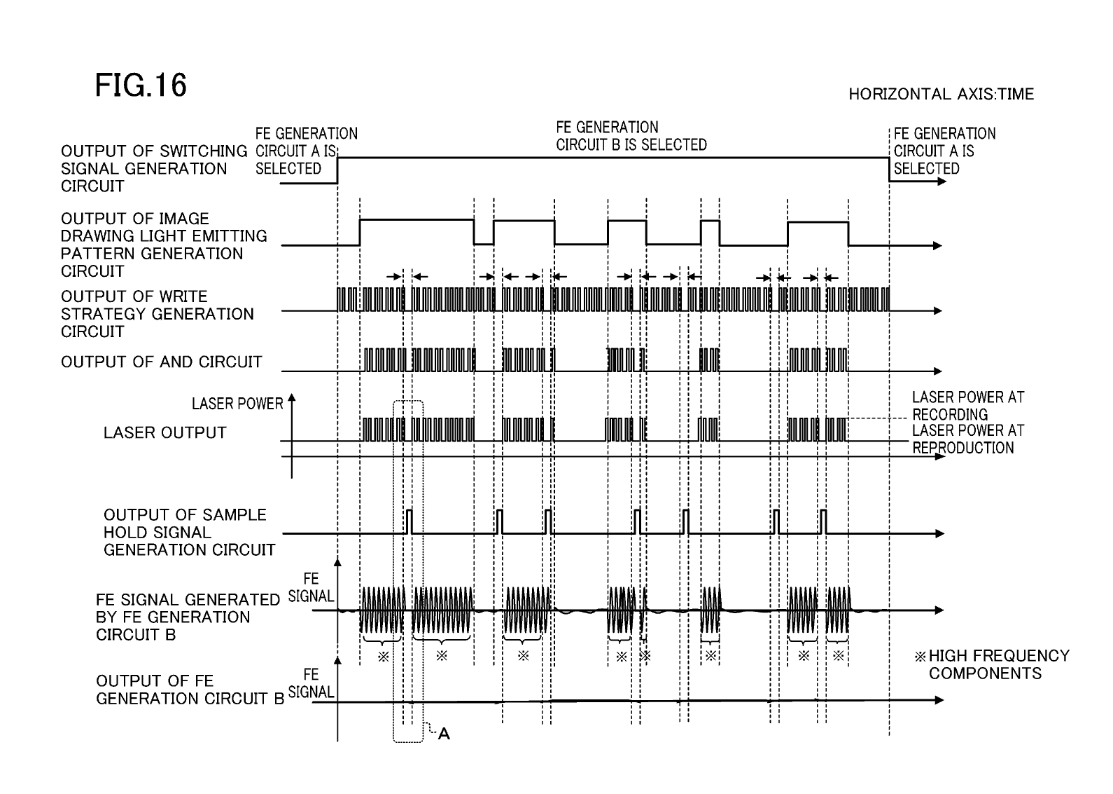

Next, respective waveforms of signals when a visible image is drawn on the label surface of the optical disc 101 will be described with reference to FIG. 16.

At a start of image drawing, according to an instruction from the micon 1328, an output voltage of the switching signal generation circuit 1313 is switched from the low level to the high level, and the switch 1310 and the switch 1311 select the FE generation circuit B1308.

A voltage level of the image drawing light emitting pattern signal output by the image drawing light emitting pattern generation circuit 1303 is at the low level or the high level according to the gray level of a visible image to be drawn on the label surface.

The extension write strategy signal output by the write strategy generation circuit 1304 is switched between the low level and the high level at about the same frequency as that of a write strategy when data to be reproduced is recorded on the optical disc 101. However, in the reproduction irradiation period (a period in which the low level continues) indicated by the extension write strategy signal, reproduction irradiation periods (periods shown by arrows in FIG. 16) exist, and each of the reproduction irradiation periods is long and does not appear when data is recorded on a CD.

When the output voltage of the image drawing light emitting pattern generation circuit 1303 is at the low level, an output voltage of the AND circuit 1305 is at the low level. When an output voltage of the image drawing light emitting pattern generation circuit 1303 is at the high level, the output voltage of the AND circuit 1305 is equal to an output voltage of the write strategy generation circuit 1304.

Power of laser output by the laser 111 serves as the reproduction laser power when the output voltage of the AND circuit 1305 is at the low level, and serves as the recording laser power when the output voltage of the AND circuit 1305 is at the high level.

An output voltage of sample hold signal generation circuit 1312 becomes the high level in the middle of the reproduction irradiation period corresponding to the detection space portion, and becomes the low level at the end of the reproduction irradiation period.

A voltage level of an FE signal generated by the FE generation circuit B1308 is not stable while the laser 111 emits light with the recording laser power, but is stable while the laser 111 emits light with the reproduction laser power.

The FE generation circuit B1308 extracts a generated FE signal and outputs the FE signal in a period in which the output voltage of the sample hold signal generation circuit 1312 is at the high level, and holds the FE signal extracted immediately before the output voltage is switched from the high level to the low level and continuously outputs the FE signal in a period in which the output voltage of the sample hold signal generation circuit 1312 is at the low level.

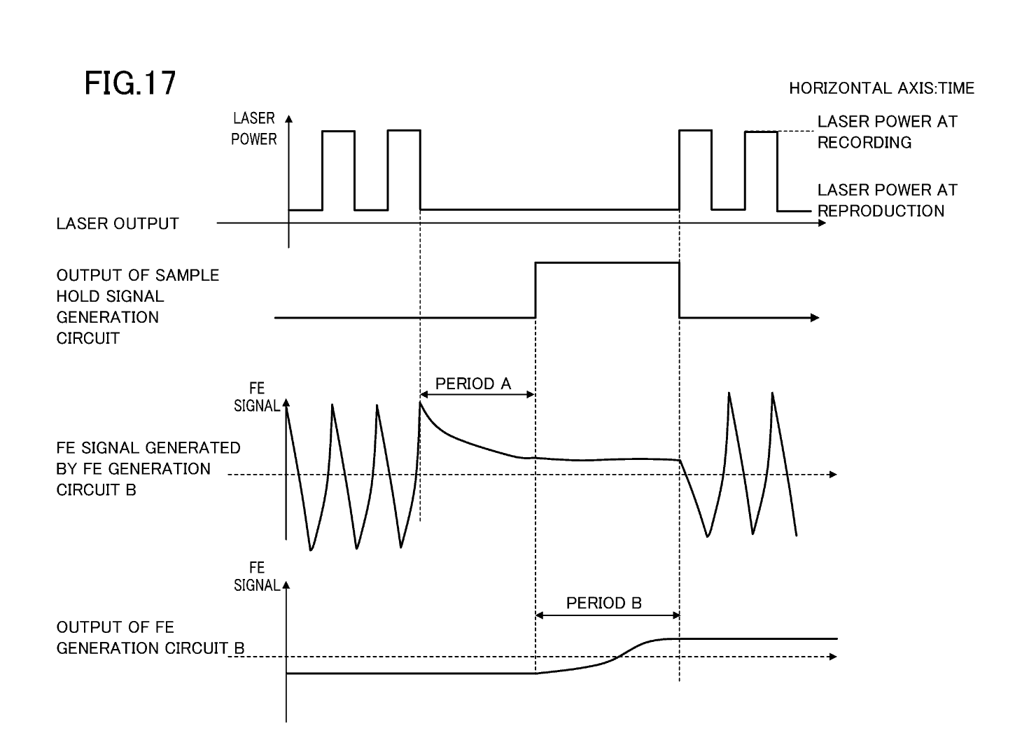

Next, a method for generating a sample hold signal will be described with reference to FIG. 17.

In FIG. 17, a period A is a period from the time when the laser 111 starts emitting light with the recording laser power to the time when the sample hold circuit 1309 starts sampling (extraction). Since the sample hold circuit 1309 can start sampling only after the FE signal generated by the FE generation circuit B1308 is stabilized, the period A has to be set to be equal to or longer than a stabilization time of the FE signal. The stabilization time depends on detection responsiveness of the optical detector 115, and therefore, the period A has to be ensured to be long enough, when the detection responsiveness of the optical detector 115 is low (i.e., a response of the optical detector 115 is slow).

A period B is a period in which the sample hold circuit 1309 performs sampling, and has to be set to be equal to or longer than a settling time of the sample hold circuit 1309.

That is, to extract the FE signal when a visible image is drawn on the label surface of the optical disc 101, a reproduction irradiation period corresponding to the detection space portion has to be set to be equal to or longer than (the stabilization time of an input signal of the FE generation circuit B1308+the settling time of the sample hold circuit 1309).

Conventionally, a continuous irradiation period of laser light with the reproduction laser power reduces, as the rotation rate of the optical disc 101 when an image is drawn and the encoding rate of the image drawing data increase. Therefore, when the responsiveness of the optical detector 115 is low, the rotation rate and the image drawing data encoding rate cannot be increased.

According to this embodiment, the space portion for detecting an FE signal is not limited to a length defined by a modulation rule employed for data to be reproduced, which is recorded in a CD. Therefore, even when the detection responsiveness of the optical detector is poor, even when the rotation rate of an optical disc and the encoding rate of image drawing data are high, and even when an image is drawn at high resolution, the detection space portion is set to a necessary length for generating an FE signal, and thus, an FE signal can be generated. Accordingly, as compared to conventional methods, image drawing at higher resolution and higher speed is allowed.

According to this embodiment, the reproduction irradiation period indicated by the write strategy signal is extended by the space portion extension circuit 1304c to generate the extension write strategy signal. However, without the space portion extension circuit 1304c, the image drawing data generation circuit 1302 may be configured to generate random data in which a value corresponding to the space portion successively appears a larger number of times than a bit number corresponding to the maximal width of the space portion defined by the EFM scheme.

### Fifth Embodiment

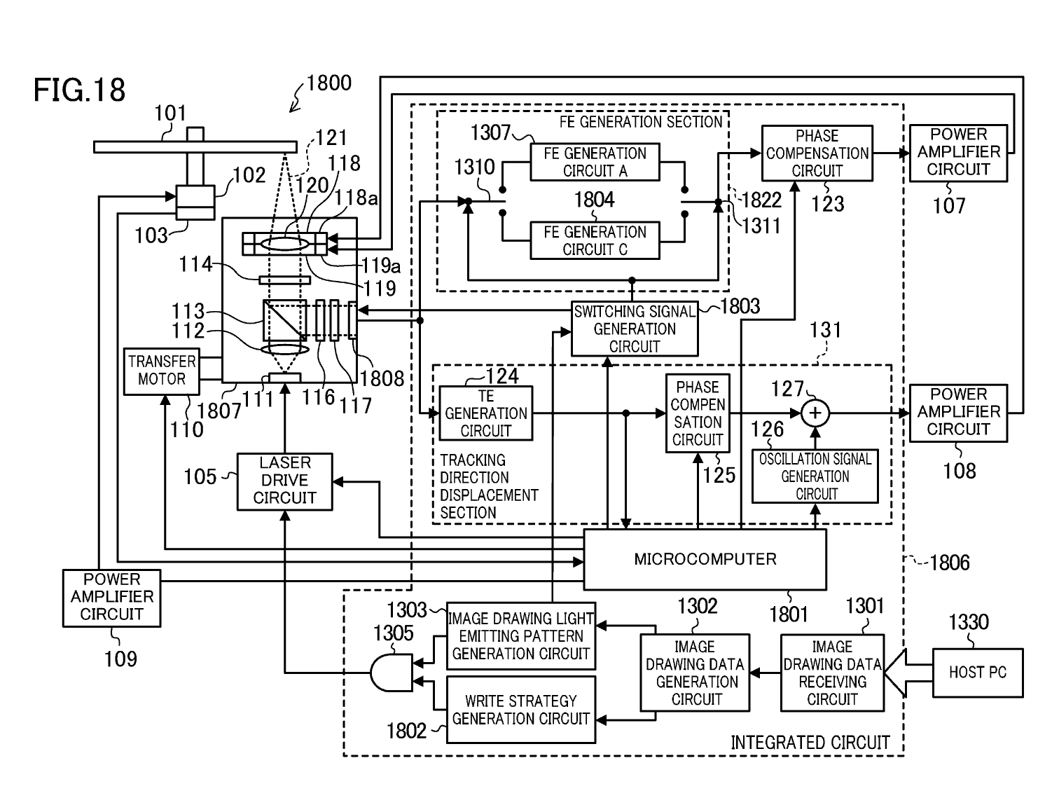

FIG. 18 illustrates an optical disc apparatus 1800 according to a fifth embodiment. Note that each member identified by the same reference character as in the fourth embodiment performs the same operation of the corresponding member in the fourth embodiment, and therefore, the description thereof will be omitted.

The optical disc apparatus 1800 includes an integrated circuit 1806, instead of the integrated circuit 106 of the first embodiment.

The integrated circuit 1806 includes an FE generation section 1822, instead of the FE generation section 1322, and a microcomputer (which will be hereinafter referred to as a micon) 1801, instead of the micon 1328. Also, the integrated circuit 1806 includes a write strategy generation circuit 1802, instead of the write strategy generation circuit 1304, and a switching signal generation circuit 1803, instead of the switching signal generation circuit 1313.

The FE generation section 1822 includes a FE generation circuit C1804, instead of the FE generation circuit B1308, and in this point, the FE generation section 1822 is different from the FE generation section 1322 of the fourth embodiment.

The FE generation circuit C1804 includes a low-pass filter configured to filter high frequency components of the FE signal (shown by a symbol with an “x” and four dots on a waveform of an input of the FE generation circuit B in FIG. 16), but the FE generation circuit A1307 does not include a low-pass filter configured to filter the high frequency components of the FE signal.

In an amplifier of the FE generation circuit A1307, a magnification scale for generating the FE signal normalized based on the reproduction laser power is set, and in an offset correction circuit of the FE generation circuit A1307, an offset for generating the FE signal normalized based on the reproduction laser power is set. In an amplifier of the FE generation circuit C1804, a magnification scale for generating the FE signal normalized based on the recording laser power is set, and in an offset correction circuit of the FE generation circuit C1804, an offset for generating the FE signal normalized based on the recording laser power is set.

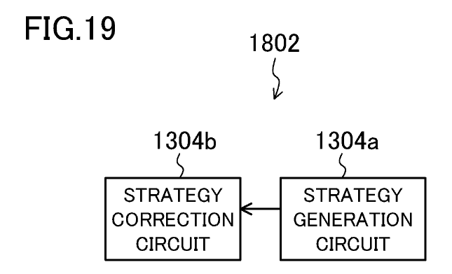

As shown in FIG. 19, the write strategy generation circuit 1802 does not include the space portion extension circuit 1304c, and in this point, the write strategy generation circuit 1802 is different from the write strategy generation circuit 1304 of the fourth embodiment.

According to an instruction from the micon 1801, the switching signal generation circuit 1803 outputs an image drawing light emitting pattern signal generated by the image drawing light emitting pattern generation circuit 1303 as it is.

The switch 1310 and the switch 1311 select the FE generation circuit A1307 when the image drawing light emitting pattern signal output by the switching signal generation circuit 1803 is at the low level, and select the FE generation circuit C1804 when the image drawing light emitting pattern signal output by the switching signal generation circuit 1803 is at the high level.

The optical disc apparatus 1800 includes an optical head 1807, instead of the optical head 104 of the fourth embodiment, and the optical head 1807 includes an optical detector 1808, instead of the optical detector 115 of the optical head 104.

When the image drawing light emitting pattern signal output by the switching signal generation circuit 1803 is at the low level, the optical detector 1808 detects reflected light of the laser light 121 from the optical disc 101 with a reproduction sensitivity for detecting the FE signal when the laser light 121 with which the optical disc 101 is irradiated has the reproduction laser power. On the other hand, when the image drawing light emitting pattern signal output by the switching signal generation circuit 1803 is at the high level, the optical detector 1808 detects reflected light of the laser light 121 from the optical disc 101 with a recording sensitivity for detecting the FE signal when the laser light 121 with which the optical disc 101 is irradiated has the recording laser power.

Similar to the micon 1328 of the fourth embodiment, the micon 1801 executes the operation shown in the flow chart of FIG. 15, when a visible image is drawn.

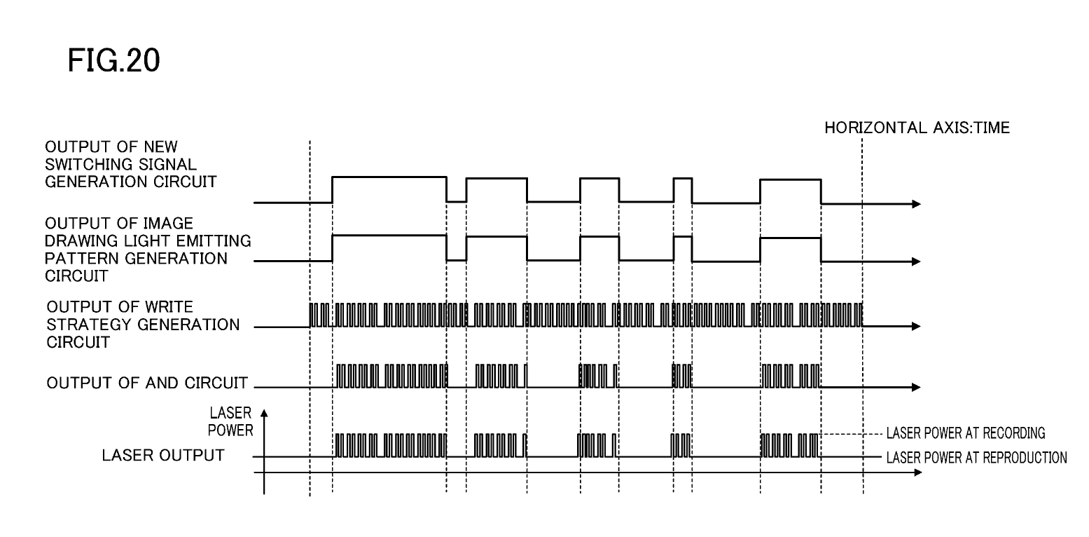

Respective waveforms of signals when a visible image is drawn on the label surface of the optical disc 101 are as shown in FIG. 20.

When the image drawing light emitting pattern signal output by the image drawing light emitting pattern generation circuit 1303 is at the low level, the switching signal generation circuit 1803 causes the optical detector 1808 to detect reflected light with the reproduction sensitivity, and activates focus control by the FE generation circuit A1307 by switching of the switches 1310 and 1311 (first control). On the other hand, when the image drawing light emitting pattern signal is at the high level, the switching signal generation circuit 1803 causes the optical detector 1808 to detect reflected light with the recording sensitivity, and activates focus control by the FE generation circuit C1804 by switching of the switches 1310 and 1311 (second control).

According to this embodiment, when the laser light 121 has the reproduction laser power, focus control is performed using the FE signal normalized based on the reproduction laser power, and when the laser light 121 has the recording laser power, focus control is performed using the FE signal normalized based on the recording laser power. Therefore, stable focus control can be performed when an image is drawn. Also, since the FE signal is generated even when laser power is set to the recording laser power, the sample hold circuit 1309 and the sample hold signal generation circuit 1312 are not necessary. Thus, a mounting area of the integrated circuit 1806 of the optical disc apparatus 1800 can be reduced.

In this embodiment, the switching signal generation circuit 1803 outputs an image drawing light emitting pattern signal as it is. However, the switching signal generation circuit 1803 may be configured to output a signal obtained by delaying the image drawing light emitting pattern signal by a predetermined period. For example, the switching signal generation circuit 1803 may be configured to output a signal obtained by delaying timings of rising and falling of the image drawing light emitting pattern signal by a time required for stabilizing focus control. Thus, a more stable FE signal can be obtained. Also, the switching signal generation circuit 1803 may be configured to output a low frequency band signal obtained by filtering components at frequencies equal to and higher than a predetermined frequency from the image drawing light emitting pattern signal.

<<Variations>>

Note that in the first and second embodiments, the displacement rate calculation circuit 404 calculates the displacement rate of the position irradiated with the laser light 121, based on an oscillation signal generated by the oscillation signal generation circuit 126. However, the displacement rate calculation circuit 404 may be configured to calculate the displacement rate, based on an output of the power amplifier circuit 108. When a visible image is drawn in an area in which a track is formed, the displacement rate may be calculated based on a TE signal generated by the TE generation circuit 124.

In the fourth and fifth embodiments, the image drawing data generation circuit 1302 generates random data according to the EFM scheme. However, the image drawing data generation circuit 1302 may be configured to generate random data with a duty ratio (i.e., the ratio of black dots in a dark area of a visible image) higher than a duty ratio defined by the EFM scheme. In the fourth embodiment, also, when the space portion extension circuit 1304c is not provided, the image drawing data generation circuit 1302 may be configured to generate random data with a duty ratio (i.e., the ratio of black dots in a dark area of a visible image) higher than the duty ratio defined by the EFM scheme. Thus, a visible image can be drawn with fewer rotations.

The present invention is not limited to the embodiments described above, but various modifications are possible. It is without mentioning that such modifications should also be included in the scope of the invention.

An optical disc apparatus and an integrated circuit according to the present disclosure are useful as an optical disc apparatus which performs image drawing of a visible image by irradiating an optical disc including a discoloration layer which is discolored by heat or light with laser light, and an integrated circuit provided in the optical disc apparatus.

What is claimed is:

1. An integrated circuit which is provided in an optical disc apparatus for drawing a visible image on an optical disc including a discoloration layer which is discolored by heat or light by irradiating the optical disc with laser light,
the integrated circuit comprising:
a tracking direction displacement section configured to execute, when the visible image is drawn, oscillation control to oscillate a position irradiated with the laser light in a radial direction of the optical disc; and
a laser modulation section configured to change, when the visible image is drawn, an intensity of the laser light so that the higher a displacement rate of the position irradiated with the laser light in the radiation direction is, the higher the intensity of the laser light becomes.

2. The integrated circuit of claim 1, wherein
the oscillation control by the tracking direction displacement section causes simple harmonic oscillation of the position irradiated with the laser light, and
the laser modulation section changes the intensity of the laser light to a lowest level when the irradiation position turns.

3. An optical disc apparatus, comprising:
the integrated circuit of claim 1.

4. An integrated circuit which is provided in an optical disc apparatus for drawing a visible image on an optical disc including a discoloration layer which is discolored by heat or light by focusing the laser light on the optical disc by a focusing section to irradiate the optical disc with laser light,
the integrated circuit comprising:
a tracking direction displacement section configured to execute, when the visible image is drawn, oscillation control to oscillate a position irradiated with the laser light in a radial direction of the optical disc; and
a focusing section position shift section configured to displace the focusing section in a direction perpendicular to the discoloration layer of the optical disc so that the higher a displacement rate of the position irradiated with the laser light in the radial direction is, the smaller a size of a spot of the laser light in the discoloration layer becomes.

5. The integrated circuit of claim 4, wherein
the oscillation control by the tracking direction displacement section causes simple harmonic oscillation of the position irradiated with the laser light, and
the focusing section position shift section displaces the focusing section in a direction perpendicular to the discoloration layer of the optical disc so that the size of the spot in the discoloration layer is largest when the irradiation position turns.

6. An optical disc apparatus, comprising:
the integrated circuit of claim 4.

7. An integrated circuit which is provided in an optical disc apparatus for drawing a visible image on an optical disc including a discoloration layer which is discolored by heat or light by irradiating the optical disc with laser light,
the optical disc apparatus including a light output section configured to output outgoing laser light, a focusing lens configured to receive and focus the outgoing laser light output by the light output section to irradiate the discoloration layer of the optical disc with the outgoing laser light as irradiation laser light, and a spherical aberration correction lens configured to correct a spherical aberration of the focusing lens,
the integrated circuit comprising:
a tracking direction displacement section configured to execute, when the visible image is drawn, oscillation control to oscillate a position irradiated with the laser light in a radial direction of the optical disc by moving a position of the focusing lens; and
a spherical aberration generation section configured to generate, when the visible image is drawn, a spherical aberration of the focusing lens by displacing the spherical aberration correction lens,
wherein
the tracking direction displacement section controls the position of the focusing lens so that when the position irradiated with the laser light is positioned at a center of an oscillation width, the entire outgoing laser light enters a photo receiving surface of the focusing lens, and when the position irradiated with the laser light turns, a part of the outgoing laser light is off the photo receiving surface of the focusing lens.

8. The integrated circuit of claim 7, wherein
the optical disc has a recording surface on which data to be reproduced is recorded, the recording surface including a pigment layer formed therein,
the spherical aberration generation section generates the spherical aberration of the focusing lens so that a spot of a radial outer beam of the outgoing laser light in discoloration layer when the visible image is drawn is smaller than a spot of the radial outer beam of the outgoing laser light in the pigment layer when the data to be reproduced is recorded on the recording surface of the optical disc and when the data is reproduced.

9. The integrated circuit of claim 7, wherein
when the spherical aberration generation section generates the spherical aberration so that a focus of the radial outer beam of the outgoing laser light is positioned in the discoloration layer of the optical disc, a focal distance of a radial inner beam of the outgoing laser light is greater than a focal distance of the radial outer beam of the outgoing laser light.

10. An optical disc apparatus, comprising:
the integrated circuit of claim 7.

11. An integrated circuit which is provided in an optical disc apparatus for drawing a visible image on an optical disc including a discoloration layer which is discolored by heat or light by irradiating the optical disc with laser light with recording laser power in a recording irradiation period indicated by a laser light emitting signal, and irradiating the optical disc with laser light with reproduction laser power in a reproduction irradiation period indicated by the laser light emitting signal,
the integrated circuit comprising:
a focus error signal generation section configured to, when the visible image is drawn, generate a focus error signal based on an amount of reflected light of the laser light with which the optical disc has been irradiated in the reproduction irradiation period, extract the generated focus error signal to output the focus error signal as it is in a predetermined extraction period, and output the focus error signal extracted in the predetermined extraction period in a period other than the predetermined extraction period; and
a laser light emitting signal generation section configured to generate a laser light emitting signal when the visible image is drawn, based on image data indicating a contrast between brightness and darkness at each dot forming the visible image, so that a detection space portion which is longer than a maximal width of a space portion defined by a modulation rule employed for recording onto a predetermined optical disc by the optical disc apparatus appears as frequently as or more frequently than a required frequency of extraction of the focus error signal,
wherein
the laser light emitting signal generation section generates a sample hold signal indicating the predetermined extraction period corresponding to the detection space portion based on the image data.

12. The integrated circuit of claim 11, wherein
the laser light emitting signal generation section includes
an image drawing data generation section configured to generate, based on the image data, image drawing light emitting pattern data and random data according to the modulation rule,
a write strategy generation section configured to generate, based on the random data generated by the image drawing data generation section, a write strategy signal indicating a recording irradiation period and a reproduction irradiation period for forming a pit corresponding to the random data, and extend the reproduction irradiation period indicated by the generated write strategy signal to generate an extension write strategy signal for forming a space portion which is longer than the maximal width of the space portion defined by the modulation rule, and
an image drawing light emitting pattern generation section configured to generate, based on the image drawing light emitting pattern data generated by the image drawing data generation section, an image drawing light emitting pattern signal indicating the recording irradiation period and the reproduction irradiation period corresponding to the image drawing light emitting pattern data, and
a signal which indicates, as the recording irradiation period, a period indicated as the recording irradiation period by both of the extension write strategy signal generated by the write strategy generation section and the image drawing light emitting pattern signal generated by the image drawing light emitting pattern generation section, and indicates, as the reproduction irradiation period, a period other than the period indicated as the recording irradiation period is generated as the laser light emitting signal.

13. The integrated circuit of claim 12, wherein
the extension of the reproduction irradiation period by the write strategy generation section is performed only to one or more of multiple ones of the reproduction irradiation period, having a specific length.

14. The integrated circuit of claim 12, wherein
when the reproduction irradiation period having a specific length successively appear a predetermined number of times, the extension of the reproduction irradiation period by the write strategy generation section is performed only to a last one of the predetermined number of successive reproduction irradiation periods.

15. The integrated circuit of claim 12, wherein
an amount of extension of the reproduction irradiation period by the write strategy generation circuit is variable.

16. The integrated circuit of claim 11, wherein
the laser light emitting generation section includes
an image drawing data generation section configured to generate, based on the image data, image drawing light emitting pattern data and random data in which a value corresponding to the space portion successively appears a larger number of times than a bit number corresponding to the maximal width of the space portion defined by the modulation rule,
a write strategy generation section configured to generate, based on the random data generated by the image drawing data generation section, a write strategy signal indicating a recording irradiation period and a reproduction irradiation period for forming a pit corresponding to the random data, and
an image drawing light emitting pattern generation section configured to generate, based on the image drawing light emitting pattern data generated by the image drawing data generation section, an image drawing light emitting pattern signal indicating the recording irradiation period and the reproduction irradiation period corresponding to the image drawing light emitting pattern data, and
a signal which indicates, as the recording irradiation period, a period indicated as the recording irradiation period by both of the write strategy signal generated by the write strategy generation section and the image drawing light emitting pattern signal generated by the image drawing light emitting pattern generation section, and indicates, as the reproduction irradiation period, a period other than the period indicated as the recording irradiation period is generated as the laser light emitting signal.

17. The integrated circuit of claim 12, wherein
the predetermined extraction period indicated by the sample hold signal generated by the laser light emitting generation section is a period indicated as the reproduction irradiation period by the write strategy signal.

18. An optical disc apparatus, comprising:
the integrated circuit of claim 11.

19. An integrated circuit which is provided in an optical disc apparatus for drawing a visible image on an optical disc including a discoloration layer which is discolored by heat or light by irradiating the optical disc with laser light with recording laser power in a recording irradiation period indicated by a laser light emitting signal, and irradiating the optical disc with laser light with reproduction laser power in a reproduction irradiation period indicated by the laser light emitting signal,
the optical disc apparatus including
an optical detector configured to be capable of detecting reflected light of the laser light from the optical disc with a reproduction sensitivity for generating a focus error signal when the laser light has the reproduction laser power, and with a recording sensitivity for generating the focus error signal when the laser light has the recording laser power,
the integrated circuit comprising:
a first focus error signal generation circuit configured to generate, based on the reflected light of the laser light detected by the optical detector, the focus error signal when the laser light has the reproduction laser power;
a second focus error signal generation circuit configured to generate, based on the reflected light of the laser light detected by the optical detector, the focus error signal when the laser light has the recording laser power;
an image drawing data generation section configured to generate, based on image data to indicate a contrast between brightness and darkness at each dot forming the visible image, image drawing light emitting pattern data, and random data according to a modulation rule employed for recording onto a predetermined optical disc by the optical disc apparatus;
a write strategy generation section configured to generate, based on the random data generated by the image drawing data generation section, a write strategy signal indicating a recording irradiation period and a reproduction irradiation period for forming a pit corresponding to the random data;
an image drawing light emitting pattern generation section configured to generate, based on the image drawing light emitting pattern data generated by the image drawing data generation section, an image drawing light emitting pattern signal indicating a recording irradiation period and a reproduction irradiation period corresponding to the image drawing light emitting pattern data;
a laser light emitting signal output section configured to generate a laser light emitting signal which indicates, as the recording irradiation period, a period indicated as the recording irradiation period by both of the write strategy signal generated by the write strategy generation section and the image drawing light emitting pattern signal generated by the image drawing light emitting pattern generation section, and indicates, as the reproduction irradiation period, a period other than the period indicated as the recording irradiation period; and
a switching section configured to, in the reproduction irradiation period indicated by the image drawing light emitting pattern signal, cause the optical detector to detect reflected light with the reproduction sensitivity, and execute first control to activate focus control by the first focus error signal generation circuit and to, in the recording irradiation period indicated by the image drawing light emitting pattern signal, cause the optical detector to detect reflected light with the recording sensitivity, and execute second control to activate focus control by the second focus error signal generation circuit.

20. The integrated circuit of claim 19, wherein
the switching section executes the first control in a period from a timing delayed from a start of the reproduction irradiation period indicated by the image drawing light emitting pattern signal by a time required for stabilizing the focus control to an end of the reproduction irradiation period, and executes the second control in a period from a timing delayed from a start of the recording irradiation period indicated by the image drawing light emitting pattern signal by a time required for stabilizing the focus control to an end of the recording irradiation period.

21. The integrated circuit of claim 19, wherein
the switching section executes the first control in the reproduction irradiation period indicated by a low frequency band signal obtained by filtering components at frequencies equal to and higher than a predetermined frequency from the image drawing light emitting pattern signal, and executes the second control in the recording irradiation period indicated by the low frequency band signal.

22. An optical disc apparatus, comprising:
the integrated circuit of claim 19.
